(19) United States
(12) Patent Application Publication
(10) Pub. No.: US 2025/0338853 A1
(43) Pub. Date: Nov. 6, 2025

(54) METHODS OF REDUCING HERBICIDAL STRESS USING HUMIC AND FULVIC ACID COMPOSITION TREATMENTS

(71) Applicant: PRO FARM GROUP, INC., Davis, CA (US)

(72) Inventor: Kalle Virta, Vantaa (FI)

(21) Appl. No.: 18/843,641

(22) PCT Filed: Mar. 3, 2023
(86) PCT No.: PCT/US2023/014463

§ 371 Date: Sep. 3, 2024

Related U.S. Application Data
(60) Provisional application No. 63/316,383, filed on Mar. 3, 2022.

(51) Int. Cl. A01N 61/00; A01N 41/06; A01N 59/00; A01P 13/00; A01P 21/00

(52) U.S. Cl. CPC A01N 61/00; A01N 41/06; A01N 59/00; A01P 13/00; A01P 21/00

(57) ABSTRACT

Disclosed herein are methods for reducing herbicide stress to a plant, the method comprising the steps of applying an herbicide to the plant; and applying to the plant and/or seeds and/or substrate used for growing said plant an effective amount of a composition comprising a composition containing fulvic acid and poly-metallic humates (CPFAPH).

### CLAIM FOR PRIORITY

This application claims priority to U.S. Provisional Application No. 63/316,383, filed Mar. 3, 2022, the entire contents of which are incorporated herein by reference.

### TECHNICAL FIELD

This disclosure relates generally to compositions, more specifically, the disclosure herein relates to soluble compositions for use in reducing stress caused to plants by herbicides.

### SUMMARY

In various aspects, methods for reducing herbicidal stress in plants are disclosed. The method for reducing herbicide stress to a plant can include the steps of: applying an herbicide to the plant; and applying to the plant and/or seeds and/or substrate used for growing said plant an effective amount of a composition comprising a composition containing fulvic acid and poly-metallic humates (CPFAPH).

According to one aspect, the herbicide is fomesafen and the plant is soybean.

In some embodiments, the herbicide stress is oxidative stress.

A method for increasing root content of a plant can include the steps of: applying an herbicide to the plant; applying to the plant and/or seeds and/or substrate used for growing said plant an effective amount of a composition comprising a composition containing fulvic acid and poly-metallic humates (CPFAPH).

A method for increasing biomass of a plant comprising the steps of: applying an herbicide to the plant; and applying to the plant and/or seeds and/or substrate used for growing said plant an effective amount of a composition comprising a composition containing fulvic acid and poly-metallic humates (CPFAPH).

A method for reducing oxidative stress to a plant, the method comprising the steps of: applying an herbicide to the plant; and applying to the plant and/or seeds and/or substrate used for growing said plant an effective amount of a composition comprising a composition containing fulvic acid and poly-metallic humates (CPFAPH).

A method for increasing antioxidant activity in a plant, the method comprising the steps of: applying an herbicide to the plant; and applying to the plant and/or seeds and/or substrate used for growing said plant an effective amount of a composition comprising a composition containing fulvic acid and poly-metallic humates (CPFAPH).

In some embodiments, the antioxidant activity is CAT antioxidant activity.

According to another aspect, the composition comprises:
a growth enhancing component comprises a co-polymer of fulvic acid and poly-metallic humates (CPFAPH) present in the amount of from about 80% to about 90% by weight, based on a total weight of the composition; a plurality of elements present in the amount of from about 3% to about 7% by weight, based on the total weight of the composition; and one or more secondary nutrients, micronutrients, and biologically active heteromolecular trace-metal complexes present in the amount of from about 3% to about 10% by weight, based on the total weight of the composition; wherein the one or more secondary nutrients, micronutrients, and biologically active heteromolecular trace-metal complexes differ from CPFAPH.

Other aspects of the disclosed subject matter, as well as features and advantages of various aspects of the disclosed subject matter, should be apparent to those of ordinary skill in the art through consideration of the ensuing description, the accompanying drawings, and the appended claims.

### BRIEF DESCRIPTION OF THE DRAWINGS

In the drawings:

FIG. 1 provides a representation of a field planting according to a study herein.

FIG. 2 is a graph representing herbicide phytotoxicity on soybean at V4 and R1.

FIG. 3 is a graph showing average protein content of soybean foliar tissue per treatment at V4.

FIG. 4 is average Oxidative Stress as TSARS of soybean foliar tissue per treatment at V4.

FIG. 5 is average Oxidative Stress as TSARS of soybean foliar tissue per treatment at R1.

FIG. 6 is average CAT Activity in Soybean foliar tissue per treatment at V4.

FIG. 7 is average GPOX activity in soybean foliar tissue per treatment at V4.

FIG. 8 is average PAL activity in soybean foliar tissue per treatment at V4.

FIG. 9 is average PPO activity in soybean foliar tissue per treatment at V4.

FIG. 10 is average β1,3 glucanase activity in soybean foliar tissue per treatment at V4.

FIG. 11 is average phenolic compound content in Soybean foliar tissue per treatment at V4.

FIG. 12 is average phenolic content in Soybean foliar tissue per treatment at R1.

FIG. 13 is average chlorophyll content in soybean foliar tissue per treatment V4.

FIG. 14 is herbicidal phytotoxicity on soybean at R1.

FIG. 15 is average protein content of soybean foliar tissue per treatment at V4.

FIG. 16 is average Oxidative Stress as TBARS of soybean foliar tissue per treatment at V4.

FIG. 17 is average Oxidative Stress as TBARS of soybean foliar tissue per treatment at R1.

FIG. 18 is average CAT Activity in Soybean foliar tissue per treatment at V4.

FIG. 19 is average GPOX activity in soybean foliar tissue per treatment at V4.

FIG. 20 is average PAL activity in soybean foliar tissue per treatment at V4.

FIG. 21 is average PPO activity in soybean foliar tissue per treatment at V4.

FIG. 22 is average β1,3 glucanase activity in soybean foliar tissue per treatment at V4.

FIG. 23 is average phenolic compound content in Soybean foliar tissue per treatment at V4.

FIG. 24 is average phenolic compound content in Soybean foliar tissue per treatment at R1.

FIG. 25 is average chlorophyll content in soybean foliar tissue per treatment V4.

FIG. 26 is average yield of soybean.

FIG. 27 is Amaranthus spp. aerial biomass per treatment.

FIG. 28 is Amaranthus spp. radical biomass per treatment.

FIG. 29 is herbicide control on Amaranthus spp. in greenhouse.

FIG. 30 is average protein content of Amaranthus' spp. foliar tissue per treatment.

FIG. 31 is average oxidative stress as TBARS of Amaranthus spp. foliar tissue per treatment.

FIG. 32 is average CAT activity in Amaranthus spp. foliar tissue per treatment.

FIG. 33 is average GPOX activity in Amaranthus spp. foliar tissue per treatment.

FIG. 34 is average PAL activity in Amaranthus spp. foliar tissue per treatment.

FIG. 35 is average PPO activity in Amaranthus spp. foliar tissue per treatment.

FIG. 36 is average β1,3 glucanase activity in Amaranthus spp. foliar tissue per treatment.

FIG. 37 is average phenolic content in Amaranthus spp. foliar tissue per treatment.

FIG. 38 is average chlorophyll content in Amaranthus spp. foliar tissue per treatment.

FIG. 39 is measured changes of gene expression for genes related to chlorophyll synthesis and oxidative stress tolerance.

FIG. 40 is measured changes of gene expression in the flavonoid paythway.

### DETAILED DESCRIPTION

This disclosure relates to a composition (also referred to herein as a “universal bio protector”, or “UBP”) that can improve reduce herbicidal stress in a plant. The composition is described in detail in U.S. Pat. No. 11,059,758, which is incorporated herein by reference in its entirety.

As used herein, the term “co-polymer of fulvic acid and poly-metallic humates” (CPFAPH) refers to a growth enhancing component having a chemical formula of, for example, (C₁₄H₁₂O₈)ₘ [C₉H₈(M₁, M₂, M₃, . . . )O₄]ₙ and a schematic structure formula of FA-(M₁, M₂, M₃, . . . )-HA, for example, FA-(K; Na; . . . )-HA, FA-(K; Cu; Zn; . . . )-HA, etc., where FA is fulvic acid, HA is humic acid and M₁, M₂, M₃ . . . are metals. The term “hydrolyzates” refers to any product of a hydrolysis reaction. The term “chelate” as used herein refers to a compound containing a ligand bonded to a central metal atom at two or more points.

The present disclosure provides a composition including a mixture of growth enhancing components (referred to herein as a “growth enhancing mixture”). Such components can include, but are not limited to, a co-polymer of fulvic acid and poly-metallic humates (CPFAPH) present in an amount of from about 80% to about 90% by weight, based on a total weight of the composition; macro nutrients (such as, nitrogen (N), phosphorous (P), and potassium (K) compounds) present in an amount of from about 3% to about 7% by weight, based on a total weight of the composition; and secondary nutrients (such as, calcium (Ca), magnesium (Mg), and sulfur(S)) and micro nutrients (such as, zinc (Zn), copper (Cu), manganese (Mn), iron (Fe), and copper (Cu)) present in an amount of from about 3% to about 10% by weight, based on the total weight of the composition. The composition mixture can also include biologically active catalytic trace-metals including, but not limited to, molybdenum (Mo), vanadium (V), cobalt (Co), and nickel (Ni). The biologically active catalytic trace-metals can be present in an amount of from about 1% to about 3% by weight, based on the total weight of the composition.

### Composition

The production of CPFAPH can be a multiple stage process. For example, in a first stage pre-oxidation can be carried out at a temperature of from about 50° C. to about 190° C., and a pressure of from about 0.5 mega Pascal (MPa) to about 3 MPa, wherein the reaction mixture is simultaneously treated with an oxygen-containing gas until a pH of from about 10.5 to about 12 is achieved. In a second stage, the process can include an oxidation that can be carried out in at a temperature of from about 170° C. to about 200° C., until pH of from about 8.5 to about 10 is achieved. The production of cellulose using a sulphite process can produce a by-product comprising concentrated solutions of lignosulphonate or lignin containing pulp. The by-product can then be recycled and used as a lignin-containing raw material in a subsequent production process.

In an alternative example, a CPFAPH can be produced through a liquid-phase oxidation of a mixture of alkaline agent solution (including, but not limited to KOH and NaOH) with an alkaline hydrolisate of peat. The production process can take place in multiple steps. In a first step, peat can be processed by hydrolysis using a 0.1 molar (M) (around 0.6%) water solution of KOH and/or NaOH with the mass ratio “alkaline solution-peat” of from about 15:5 to about 7:5 for 72 hours at a temperature of from about 15° C. to about 25° C. and atmospheric pressure (1 atm) A second step can include raising the alkaline agent solution concentration to about 2.0±0.1% and the saturation of the peat pulp by hot air at a temperature of about 90° C. to about 100° C. and atmospheric pressure with the saturation of the reactor working space with air 2.5±0.2 m³/min m³. After about 2.5±0.5 hours of liquid-phase oxidation, the solution of synthesized CPFAPH can be separated from the peat pulp by centrifugation.

In at least one example, the CPFAPH mixture described herein can comprise from about 18% to about 20% by weight dry substances, from about 1% to about 5% by weight ashes, and from about 70% to about 75% by weight organics, based on the total weight of the composition; and have a pH of from about 9 to about 10.

In at least one example, prior to the second step of the process described above, fulvic acid (having an average chemical formula C₁₃₅H₁₈₂O₉₅N₅S₂) and humic acid (having an average chemical formula C₁₈₇H₁₈₆O₈₉N₉S₁) can be introduced into the reaction mixture having nitrogen (N) and sulfur(S). The N and S can function as alloying elements in the finished CPFAPH.

To prepare the CPFAPH into the reaction mixture must be introduced specific poly-metallic catalysts which can be in the form of suitable water-soluble compounds. These catalysts can include, but are not limited to, metals that are considered secondary nutrients (such as, calcium (Ca), magnesium (Mg)), and micro nutrients (such as, zinc (Zn), copper (Cu), manganese (Mn), iron (Fe), and the like). The above described metals can remain, at least in part, in the end-solution of CPFAPH in the form of humic chelates.

Chelated nutrients can be beneficial in both seed treatment and foliar application. Plant leaves and seeds can have waxy coatings to help prevent them from drying out. However, the wax can also repel both water and inorganic substances, preventing inorganic nutrients from penetrating the seed or leaf. Metal-organic chelate molecules are able to penetrate the waxy layers. Once absorbed, the chelate can release nutrients to be used by the plant.

The end-product of CPFAPH can contain at least a certain amount of chelated micro nutrients; however chelates having humic ligands are not stable at the high temperatures typically used during the drying processes. Therefore, additional stable chelated micro nutrients can be introduced into the end-product, including the UBP mix. A chelating agent can be prepared having chelated calcium (Ca), magnesium (Mg), zinc (Zn), and copper (Cu) and can also include ethylenediaminetetraacetic acid (EDTA). In the alternative, the preparation of a chelated manganese (Mn) and iron (Fe) can be used as a chelating agent ethylenediamine-N,N′-bis (2-hydroxyphenylacetic acid) EDDHA). The iron and manganese of the EDDHA chelates are stable in solution having a high pH, even at high temperatures. Such chelated micro nutrients can be produced by variety of well-known methods and are also commercially available from a variety of sources.

The chelated micro nutrients can then be introduced into a heated end-product of CPFAPH to form heteromolecular metal complexes having two types of ligands, humic compounds and EDTA or EDDHA ligands. Compared to conventional EDTA and EDDHA chelates, the heteromolecular chelated micro nutrients described herein can be more biologically active.

Biologically active trace-metals such as molybdenum (Mo), vanadium (V), nickel (Ni), and cobalt (Co) have been found to play an important role in plant metabolism. Ni, in low concentrations, has been found to fulfill a variety of essential roles in plants, including being a constituent of several metallo-enzymes such as urease, superoxide dismutase, NiFe hydrogenases, methyl coenzyme M reductase, carbon monoxide dehydrogenase, and the like. Therefore, Ni deficiencies in plants can reduce urease activity, disturb N assimilation, and reduce scavenging of superoxide free radical. Cobalt can significantly increase nitrogenase activity and is an essential element for the synthesis of vitamin B12. As such, cobalt can be especially important for crops, such as legumes, due to the ability of symbiotic microorganisms to fix to atmospheric nitrogen.

A trace-metal deficiency can produce an array of negative effects on the growth and metabolism of plants. These effects can include, but are not limited to, reduced growth and induction of senescence, leaf and meristem chlorosis, alterations in N metabolism, and reduced iron uptake. Providing trace-metal fertilization through foliar sprays can allow for effective elimination of internal trace-metal deficiency and raise the activity of metallo-enzymes, promoting stem elongation and leaf disc expansion, number of branches and leaves, and leaf area index.

In one embodiment, the effective seed treatment and foliar application of the composition can include heteromolecular trace-metal complexes. A heteromolecular metal complex can have a general formula of [CPFAPH]ₘ-Mₓ-[O]ₙ, where O is a multi-valent organic molecule and M is any metal in any oxidation state; wherein the values of n, x, and m are associated with a metal coordination number and a number of complex centers in organic molecules H and O. For example, hydroxy acids (citric, oxalic, succinic, malic, etc.), phthalic acid, salicylic acid, acetic acid and derivatives, gluconic acid and derivatives can be used as multi-valent organic molecules having chelating capacity. In at least one example, production of the present composition can only include the carboxylic acids that are known to participate in plant metabolism; specifically citric acid (C₆H₈O₇), gluconic acid (HOCH₂—(CHOH)₄—COOH), oxalic acid (HOOC—COOH), tartaric acid (HOOC—CHOH—CHOH—COOH), and their derivatives.

In another embodiment, a method for the synthesis of heteromolecular metal complexes can consist of preparing an O-Metal complex, and subsequently adding the O-Metal complex to the CPFAPH, under predetermined pH (such as a pH of about 8±1), pressure (such as atmospheric pressure), and temperature conditions (such as about 25±5° C.). For example, the synthesis of a mixture of heteromolecular humate-molybdenum, cobalt, and nickel citrate complexes can consist of two stages: the first stage can be the preparation of Mo, Co, and Ni citrates. For each mole of citric acid, 3 moles of Mo/Co/Ni and 14 moles of ammonia are reacted in an aqueous medium. The solid product obtained from the reaction can contain about 30% by weight of Mo/Co/Ni as a mixture of ammoniated Mo/Co/Ni citrate. During the second stage, the solution of ammoniated Mo/Co/Ni citrate can be mixed in equivalent proportion with a 15% solution of CPFAPH kept under constant stirring. In at least one example, the pH of the reaction can be adjusted to about 9. The reaction can be conducted at about 25° C. and a pressure of about 1 atmosphere. In at least one example, the reaction can continue at this temperature and pressure for about 4 hours, the resulting product may contain about 3% of Mo/Co/Ni by weight, based on a total weight of the dry mass of the solution, chelated by the heteromolecular humate-citrate system.

The composition set forth above may be combined with another microorganism and/or pesticide (e.g., nematicide, bactericide, fungicide, insecticide). The microorganism may include but is not limited to an agent derived from Bacillus spp., Paecilomyces spp., Pasteuria spp. Pseudomonas spp., Brevabacillus spp., Lecanicillium spp., non-Ampelomyces spp., Pseudozyma spp., Streptomyces spp, Burkholderia spp, Trichoderma spp, Gliocladium spp. or other Muscodor strains. Alternatively, the agent may be a natural oil or oil-product having nematicidal, fungicidal, bactericidal and/or insecticidal activity (e.g., paraffinic oil, tea tree oil, lemongrass oil, clove oil, cinnamon oil, citrus oil, rosemary oil, pyrethrum). The composition may further comprise a nematicide. This nematicide may include but is not limited to chemicals such as organophosphates, carbamates, and fumigants, and microbial products such as avermectin, Myrothecium spp., Biome (Bacillus firmus), Pasteuria spp., Paecilomyces spp., and organic products such as saponins and plant oils.

In the case that the composition is applied to a seed, the composition may be applied to the seed as one or more coats prior to planting the seed using one or more seed coating agents including, but are not limited to, ethylene glycol, polyethylene glycol, chitosan, carboxymethyl chitosan, peat moss, resins and waxes or chemical fungicides or bactericides with either single site, multisite or unknown mode of action using methods known in the art.

The composition may be coated on to a conventional seed as noted above. In a particular embodiment, the compositions set forth above may be coated on a barley seed. The coated barley seed may further comprise protein-based ingredients such as milk, whey protein, high protein based flour from e.g., rice or wheat to enhance the storage life of said seeds. Alternatively, the composition may be coated on a genetically modified seed such as Liberty Link (Bayer CropScience), Roundup Ready seeds (Monsanto), or other herbicide resistant seed, and/or seeds engineered to be insect resistant, or seeds that are “pyrimaded” with more than one gene for herbicide, disease, and insect resistance or other stress, such as drought, cold, salt resistance traits.

### Application of Composition

The compositions disclosed herein can be readily adapted for application by methods including, but not limited to, drip irrigation, hydroponics, and aeroponics. Prior to seed treatment, the dry composition can be dissolved in pure water (for example, non-chlorinated water) to form the solution with a mass concentration of about 0.2% to about 1.0% by weight, based on a total weight of the composition solution. In an alternative example, the mass concentration can be from about 0.2% to about 2.0% by weight, based on a total weight of the composition solution. Seeds can be soaked in the composition for several hours prior to planting.

In at least one example of foliar application the composition can be administered in an amount ranging from about 0.05 to about 0.25 kg per hectare in the form of a water solution with mass concentration from about 0.02% to about 0.15% and most preferably about 0.05%. In another example, the composition can be administered in an amount ranging from about 0.1 to about 0.5 kg per hectare. In a third example, the composition can be administered in an amount ranging from about 0.045 pounds per acre to about 0.225 pounds per acre. In a fourth example, the composition can be administered in an amount ranging from about 0.09 pounds per acre to about 0.45 pounds per acre. In fifth example, the composition can be administered in an amount of about 0.135 pounds per acre. In a sixth example, the water solution can have a mass concentration of about 0.05%. In practice, about 2 to about 4 foliar applications can be applied during vegetation season; however, the frequency of application can be adjusted based on crops and other relevant factors.

In at least one embodiment, the composition can be applied through the use of one or more spray tanks. The composition can be completely water soluble, and compatible with common, commercially available, compositions and pesticides. The required amount of enhanced composition, or UBP composition, can be added directly into partly filled spray tank under constant agitation.

In an alternative example, the composition can be dried as described above and placed into nutrient solution to be used in drip irrigation, hydrophonics, or aerophonics.

Application of the composition can be adjusted based on crop-specific recommendations, which can affect one or more of the application method, time of application, rate of application, and fertilization formulation. Some crops which can benefit from the application of the composition disclosed herein include, but are not limited to, fruits, grapes, nuts, citrus, coffee, watermelon, potatoes, tomatoes, peppers, cucumbers, row crops (such as cotton, sunflower, corn, wheat, rye, oats, millet, sorghum, rice and soybeans), as well as other edible, commercial, and ornamental plants.

In at least one example, the composition described herein can be configured for rapid seed and leaf penetration, highly efficient nutrient uptake, and full utilization in plant metabolism. Additionally, use of the composition disclosed herein can decrease the amount of mineral compositions, fungicides, herbicides and insecticides typically necessary to promote plant growth by about 25%.

### Uses

As noted above, the compositions set forth above may be applied using methods known in the art. These compositions may be applied to and around plants or plant parts, or applied to plants or the soil adjacent to the plants.

Crop plants can be plants which can be obtained by conventional plant breeding and optimization methods or by biotechnological and genetic engineering methods or by combinations of these methods, including the transgenic plants and including the plant cultivars protectable or not protectable by plant breeders' rights. Plant parts are to be understood as meaning all parts and organs of plants above and below the ground, such as shoot, leaf, flower and root, examples which may be mentioned being leaves, needles, stalks, stems, flowers, fruit bodies, fruits, seeds, roots, tubers and rhizomes. The plant parts also include, but are not limited to, harvested material, and vegetative and generative propagation material, for example cuttings, tubers, rhizomes, offshoots and seeds.

Plants that may be treated include but are not limited to: (A) Major edible food crops, which include but are not limited to (1) Cereals (African rice, barley, durum wheat, einkorn wheat, emmer wheat, finger millet, foxtail millet, hairy crabgrass, Indian barnyard millet, Japanese barnyard millet, maize, nance, oat, pearl millet, proso millet, rice, rye, sorghum, Sorghum spp., rye, spelt wheat); (2) Fruits (e.g., abiu, acerola, achacha, African mangosteen, alpine currant, ambarella, American gooseberry, American persimmon, apple, apricot, arazá, Asian palmyra palm, Asian pear, atemoya, Australian desert raisin, avocado, azarole, babaco, bael, banana, Barbados gooseberry, bergamot, betel nut, bignay, bilberry, bilimbi, binjai, biriba, bitter orange, black chokeberry, black mulberry, black sapote, blackberry, blue-berried honeysuckle, borojo, breadfruit, murmese grape, button mangosteen, cacao, calamondin, canistel, cantaloupe, cape gooseberry, cashew nut, cassabanana, cempedak, charichuelo, cherimoya, cherry, cherry of the Rio Grande, cherry plum, Chinese hawthorn, Chinese white pear, chokeberry, citron, cocona, coconut, cocoplum, coffee, coffee Arabica, coffee robusta, Costa Rica pitahaya, currants, custard apple, date, date-plum, dog rose, dragonfruit, durian, elderberry, elephant apple, Ethiopian eggplant, European nettle tree, European wild apple, feijoa, fig, gac, genipapo, giant granadilla, gooseberry, goumi, grape, grapefruit, great morinda, greengage, guava, hardy kiwi, hog plum, horned melon, horse mango, Indian fig, Indian jujube, jabuticaba, jackberry, jackfruit, Japanese persimmon, Japanese wineberry, jocote, jujube, kaffir lime, karanda, kei apple, kepel apple, key lime, kitembilla, kiwi fruit, korlan, kubal vine, kuwini mango, kwai muk, langsat, large cranberry, lemon, Liberian coffee, longan, loquat, lychee, malay apple, mamey sapote, mammee apple, mango, mangosteen, maprang, marang, medlar, melon, Mirabelle plum, miracle fruit, monkey jack, moriche palm, mountain papaya, mountain soursop, mulberry, naranjilla, natal plum, northern highbush blueberry, olive, otaheite gooseberry, oval kumquat, papaya, para guava, passion fruit, pawpaw, peach, peach-palm, pear, pepino, pineapple, pitomba Eugenia luschnathiana, pitomba talisia esculenta, plantain, plum, pomegranate, pomelo, pulasan, purple chokeberry, quince, rambutan, ramontchi, raspberry, red chokeberry, red currant, red mulberry, red-fruited strawberry guava, rhubarb, rose apple, roselle, safou, salak, salmonberry, santol, sapodilla, satsuma, seagrape, soncoya, sour cherry, soursop, Spanish lime, Spanish tamarind, star apple, starfruit, strawberry, strawberry guava, strawberry tree, sugar apple, Surinam cherry, sweet briar, sweet granadilla, sweet lime, tamarillo, tamarind, tangerine, tomatillo, tucuma palm, Vaccinium spp., velvet apple, wampee, watermelon, watery rose apple, wax apple, white currant, white mulberry, white sapote, white star apple, wolfberry (Lyceum barbarum, L. chinense), yellow mombin, yellow pitaya, yellow-fruited strawberry, guava, (3) Vegetables (e.g., ackee, agate, air potato, Amaranthus spp., American groundnut, antroewa, armenian cucumber, arracacha, arrowleaf elephant ear, arrowroot, artichoke, ash gourd, asparagus, avocado, azuki bean, bambara groundnut, bamboo, banana, Barbados gooseberry, beet, beet root, bitter gourd, bitter vetch, bitterleaf, black mustard, black radish, black salsify, blanched celery, breadfruit, broad bean, broccoli, Brussels sprout, Buck's horn plantain, buttercup squash, butternut squash, cabbage, caigua, calabash, caraway seeds, carob, carrot, cassabanana, cassava, catjang, cauliflower, celeriac, celery, celtuce, chard, chayote, chickpea, chicory, chilacayote, chili pepper (Capsicum annuum, C. baccatum, C. chinense, C. frutescens, C. pubescens), Chinese cabbage, Chinese water chestnut, Chinese yam, chives, chufa sedge, cole crops, common bean, common purslane, corn salad, cowpea, cress, cucumber, cushaw pumpkin, drumstick tree, eddoe, eggplant, elephant foot yam, elephant garlic, endive, enset, Ethiopian eggplant, Florence fennel, fluted gourd, gac, garden rocket, garlic, geocarpa groundnut, Good King Henry, grass pea, groundnut, guar bean, horse gram, horseradish, hyacinth bean, ice plant, Indian fig, Indian spinach, ivy gourd, Jerusalem artichoke, jacamar, jute, kale, kohlrabi, konjac, kurrat, leek, lentil, lettuce, Lima bean, lotus, luffa, maca, maize, mangel-wurzel, mashua, moso bamboo, moth bean, mung bean, napa cabbage, neem, oca, okra, Oldham's bamboo, olive, onion, parsnip, pea, pigeon pea, plantain, pointed gourd, potato, pumpkins, squashes, quinoa, radish, rapeseed, red amaranth, rhubarb, ribbed gourd, rice bean, root parsley, runner bean, rutabaga, sago palm, salsify, scallion, sea kale, shallot, snake gourd, snow pea, sorrel, soybean, spilanthes, spinach, spinach beet, sweet potato, taro, tarwi, teasle gourd, tepary bean, tinda, tomato, tuberous pea, turnip, turnip-rooted chervil, urad bean, water caltrop Trapa bicornis, water caltrop Trapa natans, water morning slory, watercress, welsh onion, west African okra, west Indian gherkin, white goosefoot, white yam, winged bean, winter purslane, yacón, yam, yard-long bean, zucchinietables); (4) Food crops (e.g., abiu, acerola, achacha, ackee, African mangosteen, African rice, agate, air potato, alpine currant, Amaranthus app., Ambarrella, American gooseberry, American groundnut, American persimmon, antroewa, apple, apricot, arazá, Armenian cucumber, arracacha, arrowleaf elephant ear, arrowroot, artichoke, ash gourd, Asian palmyra palm, Asian pear, asparagus, atemoya, Australian desert raisin, avocado, azarole, azuki bean, babaco, bael, bambara groundnut, bamboo, banana, barbados gooseberry, barley, beet, beetroot, bergamot, betel nut, bignay, bilberry, bilimbi, binjai, biriba, bitter gourd, bitter orange, bitter vetch, bitterleaf, black chokeberry, black currant, black mulberry, black mustard, black radish, black salsify, black sapote, blackberry, blanched celery, blue-berried honeysuckle, borojó, breadfruit, broad bean, broccoli, Brussels sprout, Buck's horn plantain, buckwheat, Burmese grape, buttercup squash, butternut squash, button mangosteen, cabbage, cacao, caigua, calabash, calamondin, canistel, cantaloupe, cape gooseberry, caraway seeds, carob, carrot, cashew nut, cassava, catjang, cauliflower, celeriac, celery, celtuce, cempedak, chard, charichuelo, chayote, cherimoya, cherry, cherry of the Rio Grande, cherry plum, chickpea, chicory, chilacayote, chili pepper (Capsicum annuum, C. baccatum, C. chinense, C. frutescens, C. pubescens), Chinese cabbage, Chinese hawthorn, Chinese water chestnut, Chinese white pear, Chinese yam, chives, chokeberry, chufa sedge, citron, cocona, coconut, cocoplum, coffee, coffee (Arabica and Robusta types), cole crops, common bean, common purslane, corn salad, Costa Rica pitahaya, cowpea, cress, cucumber, currants, cushaw pumpkin, custard apple, date, date-plum, dog rose, dragonfruit, drumstick tree, durian, durum wheat, eddoe, eggplant, einkorn wheat, elderberry, elephant apple, elephant foot yam, elephant garlic, emmer wheat, endive, enset, Ethiopian eggplant, European nettle tree, European wild apple, feijoa, fig, finger millet, Florence fennel, fluted gourd, foxtail millet, gac, garden rocket, garlic, genipapo, geocarpa groundnut, giant granadilla, good king henry, gooseberry, goumi, grape, grapefruit, grass pea, great morinda, greengage, groundnut, grumichama, guar bean, guava, hairy crabgrass, hardy kiwi, hog plum, horned melon, horse gram, horse mango, horseradish, hyacinth bean, iceplant, Indian barnyard millet, Indian fig, Indian jujube, Indian spinach, ivy gourd, jabuticaba, jackalberry, jackfruit, jambul, Japanese barnyard millet, Japanese persimmon, Japanese wineberry, Jerusalem artichoke, jocote, jujube, jute, kaffir lime, kale, karanda, kei apple, kepel apple, key lime, kitembilla, kiwifruit, kohlrabi, konjac, korlan, kubal vine, kurrat, kuwini mango, kwai muk, langsat, large cranberry, leek, lemon, lentil, lettuce, Liberian coffee, lima bean, longan, loquat, lotus, luffa, lychee, maca, maize, malay apple, mamey saptoe, mammee apple, mangel-wurzel, mango, mangosteen, maprang, marang, mashua, medlar, melon, Mirabelle plum, miracle fruit, monk fruit, monkey jack, moriche palm, moso bamboo, moth bean, mountain papaya, mountain soursop, mulberry, mung bean, mushrooms, nance, napa cabbage, naranjilla, natal plum, neem, northern highbush blueberry, oat, oca, oil palm, okra, old man's bamboo, olive, onion, orange, otaheite gooseberry, oval kumquat, papaya, para guava, parsnip, passionfruit, pawpaw, pea, peach, peach-palm, pear, pearl millet, pepino, pigeon pea, pineapple, Pitomba (Eugenia luschnathiana, Talisia esculenta), plantain, plum, pointed gourd, pomegranate, pomelo, potato, proso millet, pulasan, pumpkins and squashes, purple chokeberry, quince, quinoa, radish, rambutan, ramontchi, rapeseed, raspberry, red amaranth, red chokeberry, red currant, red mulberry, red-fruited strawberry guava, rhubarb, ribbed gourd, rice, rice bean, root parsley, rose apple, roselle, runner bean, rutabaga, rye, safou, sago palm, salak, salmonberry, salsify, santol, sapodilla, Satsuma, scallion, sea kale, seagrape, shallot, snake gourd, snow pea, soncoya, sorghum, Sorghum spp., sorrel, sour cherry, soursop, soybean, Spanish lime, Spanish tamarind, spelt wheat, spilanthes, spinach, spinach beet, star apple, starfruit, strawberry, strawberry guava, strawberry tree, sugar apple, sugar beet, sugarcane, surinam cherry, sweet briar, sweet granadilla, sweet lime, sweet potato, tamarillo, tamarind, tangerine, taro, tarwi, teasle gourd, tef, tepary bean, tinda, tomatillo, tomato, tuberous pea, tucuma palm, turnip, turnip-rooted chervil, urad bean, Vaccinium spp., velvet apple, wampee, water caltrop (Trapa bicornis, T. natans), water morning glory, watercress, watermelon, watery rose apple, wax apple, welsh onion, west African okra, west Indian gherkin, wheat, white currant, white goosefoot, white mulberry, white sapote, white star apple, white yam, winged bean, winter purslane, wolfberry (Lycium barbarum, L. chinense), yacón, yam, yangmei, yard-long bean, yellow mombin, yellow pitaya, yellow-fruited strawberry guava, zucchini; (B) Other edible crops, which includes but is not limited to (1) Herbs (e.g., Absinthium, alexanders, basil, bay laurel, betel nut, camomile, chervil, chili pepper (Capsicum annuum, C. baccatum, C. chinense, C. frutescens, C. pubescens), chili peppers, chives, cicely, common rue, common thyme, coriander, cress, culantro, curly leaf parsley, dill, epazote, fennel, flat leaf parsley, ginseng, gray santolina, herb hyssop, holy basil, hop, jasmine, kaffir lime, lavender, lemon balm, lemon basil, lemon grass, lovage, marjoram, mint, oregano, parsley, peppermint, perilla, pot marigold, rooibos, rosemary, sage, shiny-leaft buckthorn, sorrel, spearmint, summer savory, tarragon, Thai basil, valerian, watercress, wild betel, winter savory, yerba mate); (2) Spices (e.g., ajowan, allspice, anise, bay laurel, black cardamom, black mustard, black pepper, caper, caraway seeds, cardamom, chili pepper (Capsicum annuum, C. baccatum, C. chinense, C. frutescens, C. pubescens), chili peppers, cinnamon, clove, common juniper, coriander, cumin, fennel, fenugreek, garlic, ginger, kaffir lime, liquorice, nutmeg, oregano, pandan, parsley, saffron, star anise, turmeric, vanilla, white mustard); (2) Medicinal plants (e.g., absinthium, alfalfa, aloe vera, anise, artichoke, basil, bay laurel, betel leat, betel nut, bilberry, black cardamom, black mustard, black pepper, blue gum, borojo, chamomile, caper, cardamom, castor bean, chili peppers, Chinese yam, chives, cola nut, common jasmine, common lavender, common myrrh, common rue, cilantro, cumin, dill, dog rose, epazote, fennel, fenugreek, gac, garlic, ginger, gray santolina, gum Arabic, herb hyssop, holy basil, horseradish, incense tree, lavender, lemon grass, liquorice, lovage, marijuana, marjoram, monk fruit, neem, opium, oregano, peppermint, pot marigold, quinine, red acacia, red currant, rooibos, safflower, sage, shiny-leaf buckthorn, sorrel, spilanthes, star anise, tarragon, tea, turmeric, valerian, velvet bean, watercress, white mustard, white sapote, wild betel, wolfberry (Lycium barbarum, L. chinense), yerba mate); (3) Stimulants (e.g., betel leaf, betel nut, cacao, chili pepper (Capsicum annuum, C. baccatum, C. chinense, C. frutescens, C. pubescens), chili peppers, coffee, coffee (Arabica, Robusta), cola nut, khat, Liberian coffee, tea, tobacco, wild betel, yerba mate); (4) Nuts (e.g., almond, betel nut, Brazil nut, cashew nut, chestnut, Chinese water chestnut, coconut, cola nut, common walnut, groundnut, hazelnut, Japanese stone oak, macadamia, nutmeg, paradise nut, pecan nut, pistachio nut, walnut); (5) Edible seeds (e.g., black pepper, Brazil nut, chilacayote, cola nut, fluted gourd, lotus, opium, quinoa, sesame, sunflower, water caltrop (Trapa bicornis, T. natans)); (6) Vegetable oils (e.g., black mustard, camelina, castor bean, coconut, cotton, linseed, maize, neem, Niger seed, oil palm, olive, opium, rapeseed, safflower, sesame, soybean, sunflower, tung tree, turnip); (7) Sugar crops (e.g., Asian palmyra palm, silver date palm, sorghum, sugar beet, sugarcane); (8) Pseudocereals (e.g., Amaranthus spp., buckwheat, quinoa, red amaranth); (9) Aphrodisiacs (e.g., borojo, celery, durian, garden rocket, ginseng, maca, red acacia, velvet bean); (C) Non food categories, including but not limited to (1) forage and dodder crops (e.g., agate, alfalfa, beet, broad bean, camelina, catjang, grass pea, guar bean, horse gram, Indian barnyard millet, Japanese barnyard millet, lespedeza, lupine, maize, mangel-wurzel, mulberry, Niger seed, rapeseed, rice bean, rye); (2) Fiber crops (e.g., coconut, cotton, fique, hemp, henequen, jute, kapok, kenaf, linseed, manila hemp, New Zealand flax, ramie, roselle, sisal, white mulberry); (3) Energy crops (e.g., blue gum, camelina, cassava, maize, rapeseed, sorghum, soybean, Sudan grass, sugar beet, sugarcane, wheat); (4) Alcohol production (e.g., barley, plum, potato, sugarcane, wheat, sorghum); (5) Dye crops (e.g., chay root, henna, indigo, old fustic, safflower, saffron, turmeric); (6) Essential oils (e.g., allspice, bergamot, bitter orange, blue gum, chamomile, citronella, clove, common jasmine, common juniper, common lavender, common myrrh, field mint, freesia, gray santolina, herb hyssop, holy basil, incense tree, jasmine, lavender, lemon, marigold, mint, orange, peppermint, pot marigold, spearmint, ylang-ylang tree); (6) Green manures (e.g., alfalfa, clover, lacy Phacelia, sunn hemp, trefoil, velvet bean, vetch); (7) Erosion prevention (e.g., bamboo, cocoplum); (8) Soil improvement (e.g., lupine, vetch); (9) Cover crops (e.g., Alfalfa, lacy Phacelia, radish); (10) Botanical pesticides (e.g., jicama, marigold, neem, pyrethrum); (11) Cut flowers (e.g., carnation, chrysanthemum, daffodil, dahlia, freesia, gerbera, marigold, rose, sunflower, tulip); (12) Ornamental plants (e.g., African mangosteen, aloe vera, alpine currant, aster, black chokeberry, breadfruit, calamondin, carnation, cassabanana, castor bean, cherry plum, chokeberry, chrysanthemum, cocoplum, common lavender, crocus, daffodil, dahlia, freesia, gerbera, hyacinth, Japanese stone oak, Jasmine, lacy Phacelia, lotus, lupine, marigold, New Zealand flax, opium, purple chokeberry, ramie, red chokeberry, rose, sunflower, tulip, white mulberry); (D) Trees which include but are not limited to abelia, almond, apple, apricot, arborvitae nigra American, arborvitae, ash, aspen, azalea, bald cypress, beautush, beech, birch, black tupelo, blackberry, blueberry, boxwood, buckeye, butterfly bush, butternut, camellia, catalpa, cedar, cherry, chestnut, coffee tree, crab trees, crabapple, crape myrtle, cypress, dogwood, Douglas fir, ebony, elder American, elm, fir, forsythia, ginkgo, goldenraintree, hackberry, hawthorn, hazelnut, hemlock, hickory, holly, honey locust, horse chestnut, hydrangea, juniper, lilac, linden, magnolia, maple, mock orange, mountain ash, oak, olive, peach, pear, pecan, pine, pistachio, plane tree, plum, poplar, pivet, raspberry, redbud, red cedar, redwood, rhododendron, rose-of-Sharon, sassafras, sequoia, serviceberry, smoke tree, soapberry, sourwood, spruce, strawberry tree, sweet shrub, sycamore, tulip tree, ciborium, walnut, weasel, willow, winterberry, witch-hazel, zelkova; (E) Turf which includes but is not limited to Kentucky bluegrass, tall fescue, Bermuda grass, zoysia grass, perennial ryegrass, fine fescues (e.g.; creeping red, chewings, hard, or sheep fescue).

Treatment of the plants, plant parts, and/or seeds with the compositions set forth above may be carried out directly or by any other suitable methods. The compositions may also be applied to the soil using methods known in the art. These include but are not limited to (a) drip irrigation or chemigation; (b) soil incorporation; (c) seed treatment. For example, the composition may be incorporated into the soil at the desired rate. The compositions, cultures, supernatants, metabolites and compounds set forth above may be used as compositions to reduce the herbicidal stress on plants, alone or in combination with one or more pesticidal substances set forth above and applied to plants, plant parts, substrate for growing plants or seeds set forth above.

The plants may also be treated at discrete steps to optimize the herbicidal effects of the compound on weeds, while minimizing negative consequences to plants. In one embodiment, the seed may be treated with a formulation according to the current disclosure. The plant may then be treated with the composition again at a later time. The timing may be adjusted according to the type of plant being grown and its particular time table for flowering, etc.

The compositions, cultures, supernatants, metabolites and compounds set forth above may be combined with other enhancing compounds for the said compositions such as, but not limited to, amino acids, chitosan, chitin, starch, hormones, minerals, synergistic microbes to increase efficacy and promote benefits to plants.

### EXAMPLES

The following examples are provided to illustrate the subject matter of the present disclosure, including the effect of the composition on crop production. These examples are not intended to limit the scope of the present disclosure, and should not be so interpreted.

### Studies 1 and 2: Herbicide Stress Reduction on Soybean Grown in Greenhouse (Study 1) and Field (Study 2)

Soybean is one of the most widely grown crops in Argentina. Weeds are considered as the number one problem in reducing yield in soybean production around the world. Weed management is becoming more complicated as some weed species have developed resistance to several herbicides such as glyphosate and ALS inhibitors, necessitating different herbicidal modes of action. Protox inhibitors, such as fomesafen, are a good alternative. However, phytotoxicity issues may appear on soybean. An approach to deal with this secondary effects of PROTOX herbicides is to use bioestimulants like UBP140 and UBP110 to reduce plant oxidative stress damage and increase defense enzymatic activity on soybean plants applied with fomesafen.

The herbicide fomesafen is one of the few latifolicides registered for common bean applied in post emergence. Characterized as susceptible an inhibitor of the protoporphyrinogen oxidase (PROTOX) enzyme, fomesafen causes death due to oxidative stress, resulting from the formation of reactive oxygen species (ROS) (Alves et al. 2018). Studies show that the application of this herbicide alone or associated with other pesticides can cause phytotoxification to the crop. Consequences include injuries such as chlorosis and necrosis foliar, flowering delay, enlargement of the cycle period, and productivity reduction (Linhares et al. 2014; Takano et al. 2015).

In this study, the effects of UBP products on the stress caused by herbicides in soybean were analyzed. In herbicide applied treatments, UBP110 presented the greatest root content significantly. UBP treatments tended to reduce oxidative stress both in absence or presence of herbicide and this tendency was maintained throughout time (V4 and R1). UBP110 and the combination of UBP110+UBP140 increased CAT antioxidant activity when herbicide was applied.

A trial in pots in greenhouse was carried out. The level of oxidative stress (TBARS) and the activity of antioxidant and defense related enzymes (CAT, GPOX, PAL, PPO and β1,3 glucanase) were analyzed. The chlorophyll and phenolic content were determined. Also, phytotoxicity and aerial and radical biomass were measured. It was determined that in absence of herbicide, UBP products tend to induce the activity of PAL, PPO and β1,3 glucanase and increase phenolic content. When herbicide is applied, they tend to increase CAT and GPOX antioxidant activity. Also, UBP140 proved to raise total chlorophyll content of herbicide treated plants significantly. An increase in aerial and radical biomass and a reduction in oxidative stress was observed when UBP products were applied, regardless herbicide application.

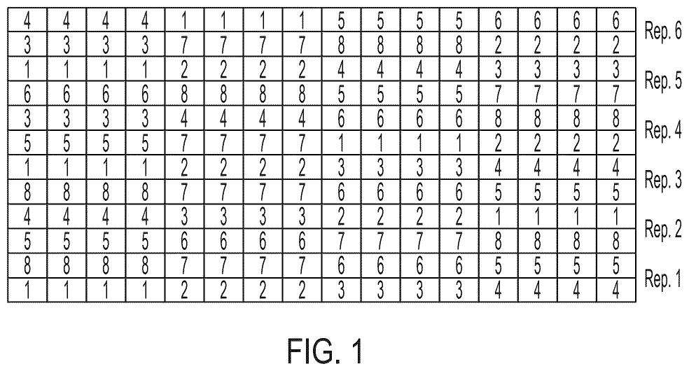

The arrangement of the trial was carried out in a complete randomized Design. Soybean plants were grown in pots in greenhouse. In a related trial, soybeans were grown in the field. FIG. 1 shows the experimental field design plan. The treatments for each pot and each field treatment are set out in Table 2. UBP 140 indicates a foliar treatment and UBP 110 indicates a seed coating treatment. The herbicide used was “Flex” by the Company Syngenta, containing 25 g of fomesafen/100 cm3 formulated as a Soluble Concentrate (SC). Dosage is shown in Table 1 where ST is seed treatment and V4 is soybean development stage.

TABLE 1
Soybean greenhouse and field treatments.

| Treat | | | | | Application |
|---|---|---|---|---|---|
| no | Product | Dose | | Herbicide** | time |
| 1 | Untreated | — | | No | — |
| | check | | | | |
| 2 | UBP 140 | *500 | cc/tn | No | ST |
| 3 | UBP 110 | 150 | g/ha | No | V4 |
| 4 | UBP 140 + | *500 cc/tn + | | No | ST + V4 |
| | UBP 110 | 150 q/ha | | | |
| 5 | Untreated | — | | 1 L/ha | — |
| | check | | | | |
| 6 | UBP 140 | *500 | cc/tn | 1 L/ha | ST/V4 |
| 7 | UBP 110 | 150 | g/ha | 1 L/ha | V4 |

| | | | | |
|---|---|---|---|---|
| 8 | UBP 140 + | *500 cc/tn + | 1 L/ha | ST + V4 |
| | UBP 110 | 150 g/ha | | |

*Total volume 5000 cc/tn seeds.
**Herbicide: fomesafen

The pots were filled with soil of the locality of San Pedro (Buenos Aires Province). Six replicates were made per treatment. The variety of Soybean used was 46R18 STS from Don Mario Company. The treatments events schedule is set forth in Table 2 for plants located in the field, and a similar schedule was followed for plants located in a greenhouse.

TABLE 2
Events schedule for treatments (field)

| Event | Date | Phen. Stg. |
|---|---|---|
| Sowing | Nov. 27, 2019 | — |
| 1^{st} Polyphenol analysis | Dec. 6, 2019 | VC |
| sampling (for Finland) | | |
| Emergence and vigour evaluation | Dec. 15, 2019 | V1 |
| UBP 110 foliar application | Jan. 4, 2020 | V4 |
| Stress analysis sampling | Jan. 6, 2020 | V4-V5 |
| 2^{nd} Polyphenol analysis | Jan. 6, 2020 | V4-V5 |
| sampling (for Finland) | | |
| Phytotoxicity evaluation | Jan. 8, 2020 | V5-V6 |
| 3^{rd} Polyphenol analysis | Jan. 15, 2020 | R1-R2 |
| sampling (for Finland) | | |
| Harvest | Apr. 8, 2018 | R6 |

For the greenhouse study, plants were irrigated and maintained at field capacity throughout the trial. The pots were rotated daily to avoid differentiated effects due to the intensity and quality of light. The average temperature during the course of the test was 28° C. The doses and time of application of the treatments are detailed in Table 1. The foliar treatments were applied with a backpack of carbon dioxide gas at 2 bars of pressure at a rate of 4.5 km/h. The application volume was 110 L/ha.

Plant vigor and stand were measured at V1-V2, while wet matter production (aerial and radical biomass) at R1. Oxidative Stress, antioxidant and defense enzyme activity were analyzed at V4, 48 h after herbicide and UBP110 application. An analysis at R1 was also carried out to evaluate TBARS and Phenolic content evolution trough time.

### Study 1 Results (Herbicide Stress Reduction on Soybean Grown in Greenhouse)

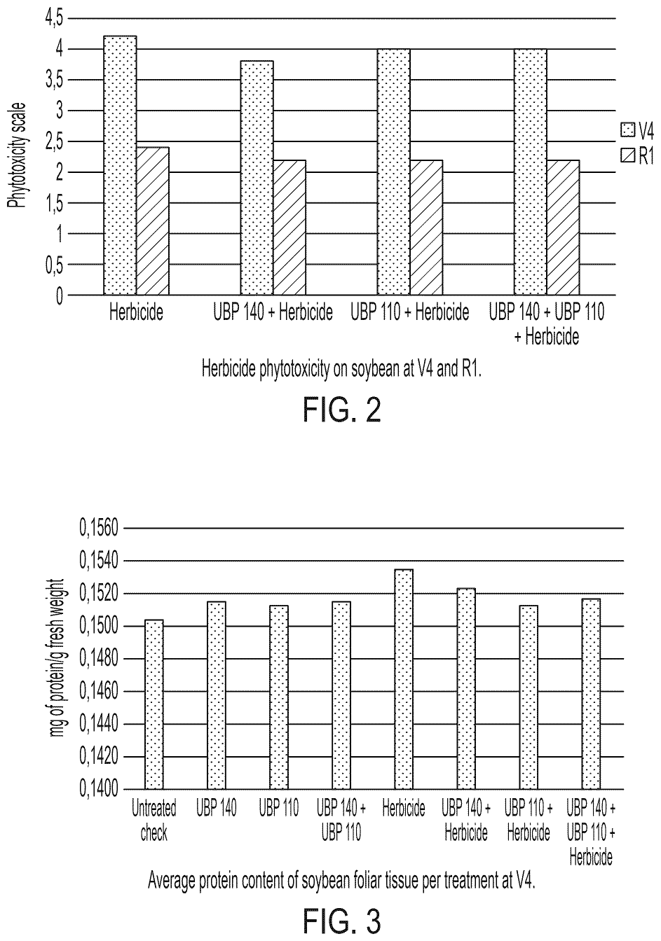

Phytotoxicity was determined at V4 and R1, 5 and 15 days after herbicide application, respectively. The scale used to measure Phytotoxicity was adapted from the EWRS (European Weed Research Society) according to Champion (2000) (1=No damage; 2=Very slight damage; 3=Slight damage; 4=Moderated damage, not affecting yield; 5=Medium damage, probable loss of yield; 6=Serious damage, loss of yield). Results of the phytotoxicity study are shown in FIG. 2 and table 3 for soybean grown in a greenhouse.

TABLE 3
Average phytotoxicity level on soybean in greenhouse
per treatment at V4 and R1. Different letters show significant
differences (α: 0.05; Kruskal-Wallis Test).

| | Phytotoxicity | | Phytotoxicity | |
|---|---|---|---|---|
| Treatment | V4 | | R1 | |
| Herbicide | 4.2 | A | 2.4 | A |
| UBP 140 + Herbicide | 3.8 | A | 2.2 | A |
| UBP 110 + Herbicide | 4 | A | 2.2 | A |
| UBP 140 + UBP110 + Herbicide | 4 | A | 2.2 | A |

To determine total proteins, an analysis was carried out according to Bradford (1976) using bovine serum albumin as a standard solution. Once the standard curve was obtained, total proteins were measured. For this purpose, 1 ml of “Bradford” solution was placed in glass hemolysis tubes and 30 μI of protein extract was added. It was mixed and allowed to stand for 2 min and then the absorbance at 595 nm was measured in spectrophotometer.

Results of the analysis for total proteins are shown in FIG. 3 and table 4 for greenhouse data. In the treatments that hadn't been applied with herbicide, UBP140 and UBP110 tended to increase total protein content (Fig.). Nevertheless, differences between treatments weren't statistically significant (Table 8). In presence of the herbicide there was a slight tendency of this to increase total protein content (FIG. 5), which was not significant (Table 8). This might be due to the fact that the stress caused by the herbicide generates the expression of a battery of proteins related to defense and the fighting against stress in the plant.

TABLE 4
Average protein content for greenhouse soybean
per treatment at V4. Different letters show significant
differences (α: 0.05; Duncan Test).

| | Protein Content | |
|---|---|---|
| | (mg of protein/g | |
| Treatment | fresh weight) | |
| Untreated check | 0.1503 | A |
| UPB 140 | 0.1515 | A |
| UPB 110 | 0.1512 | A |
| UBP 140 + UBP 110 | 0.1515 | A |
| Herbicide | 0.1535 | A |
| UBP 140 + Herbicide | 0.1523 | A |
| UBP 110 + Herbicide | 0.1512 | A |
| UBP 140 + UBP110 + Herbicide | 0.1517 | A |

TBARS and the Phenolic content of the crop were measured to determine oxidative stress. To measure Thiobarbituric Acid Reactive Substances (TBARS), fresh foliar tissue samples were homogenized in a 20% (w/v) trichloroacetic acid solution (TCA) and centrifuged at 3500×g for 20 min. To an aliquot of that supernatant (1 ml), it was added 1 ml of 20% (w/v) TCA solution containing 0.5% (w/v) thiobarbituric acid and 100 μI of 4% butylated hydroxytoluene in ethanol. The mixture was heated at 95° C. for 30 min and cooled in ice, then centrifuged at 10,000×g for 15 min and the absorbance at 532 nm was determined in spectrophotometer. The concentration of TSARS was calculated using the molar extinction coefficient of 155/mM·cm (Zilli et al., 2009).

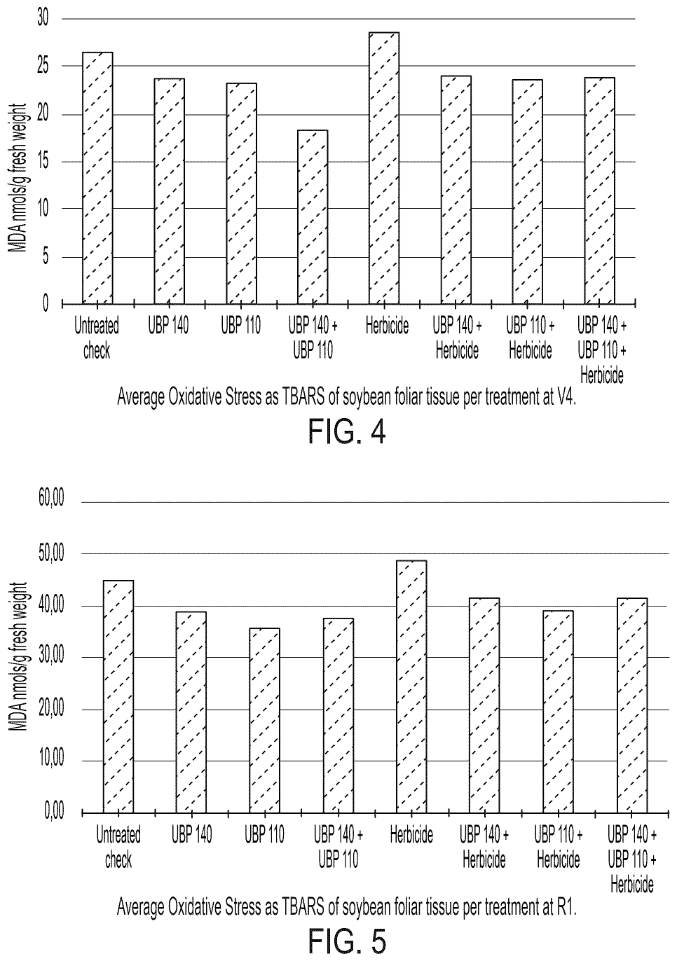

The results of the oxidative stress measurement by TBARS are shown in FIG. 4 and Table 5 for time V4. When herbicide was not applied, all treatments with UBP tended to reduce the oxidative stress of the crop, being UBP140+UBP110 the one with the best performance. This last treatment significantly diminished stress of soybean plants compared with the control (Table 5). In the cases treated with herbicide, both UBP140, UBP110 and its combination (UBP140+UBP110) produced a significant decrease of the stress of the crop.

TABLE 5
Average TBARS content per treatment at V4. Different letters
show significant differences (α: 0.05; Duncan Test).

| | TBARS | | | |
|---|---|---|---|---|
| | (MDA nmols/g | | | |
| Treatent | fresh weight) | | | |
| Untreated check | 26.42 | A | B | |
| UPB 140 | 23.68 | | B | |
| UPB 110 | 23.17 | | B | |
| UBP 140 + UBP 110 | 18.19 | | | C |
| Herbicide | 28.45 | A | | |
| UBP 140 + Herbicide | 23.84 | | B | |
| UBP 110 + Herbicide | 23.49 | | B | |
| UBP 140 + UBP110 + Herbicide | 23.74 | | B | |

At R1, treatments with UBP tended to reduce the stress of the plants both in absence or presence of herbicide. UBP110 showed the lower levels of stress and reduced TBARS significantly compared to controls.

TABLE 6
Average TBARS content per treatment at R1. Different letters
show significant differences (α: 0.05; Duncan Test).

| | TBARS | | | |
|---|---|---|---|---|
| | (MDA nmols/g | | | |
| Treatment | fresh weight) | | | |
| Untreated check | 44.91 | A | B | |
| UPB 140 | 38.77 | | B | C |
| UPB 110 | 35.66 | | | C |
| UBP 140 + UBP 110 | 37.40 | | B | C |
| Herbicide | 48.91 | A | | |
| UBP 140 + Herbicide | 41.50 | A | B | C |
| UBP 110 + Herbicide | 38.88 | | B | C |
| UBP 140 + UBP110 + Herbicide | 41.18 | A | B | C |

To determine the activity of antioxidant and defense enzymes, first, the enzymatic extraction of leaf tissues was carried out. For this purpose, a 50 mM Pil<extraction buffer pH 7.2, was made. The foliar tissue samples were homogenized with the extraction buffer (1/10 w/v) and 0.05 g of polyvinylpyrrolidone (PVP). Then, they were centrifuged for 30 min at 15,000 rpm, at a temperature of 4° C. The obtained supernatant enzyme extract was kept in freezer at −80° C. until the time of determinations (Balestrasse et al., 2001).

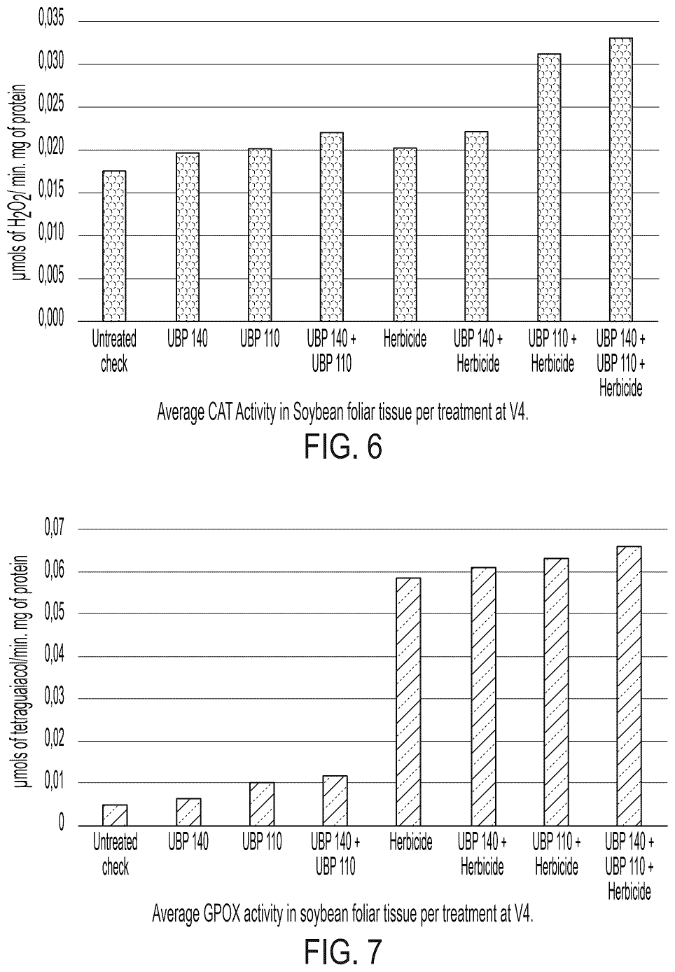

To determine enzyme activity of CAT, the reaction medium contained 30 μI of homogenate, 950 μI 50 mM potassium phosphate buffer (pH 7.2) and 20 μI of 2 mM H₂O₂ solution. The activity of CAT was determined at 30° C., measuring the decrease in absorbance at 240 nm due to the consumption of hydrogen peroxide. The pseudofirst-order reaction constant (k′=k [CAT]) of the decrease of absorbance of H₂O₂ was determined and the activity of CAT was expressed in μmol of H₂O₂/minute·mg of protein (Chance et al., 1979). The activity of CAT tended to be induced by UBP products both in herbicide applied and not applied treatments (FIG. 6). Also, UBP110 alone or in combination with UBP140 generated a significant increase of CAT antioxidant activity regardless of the herbicide application. This was more marked in the presence of UBP140. In general, plants treated with herbicide showed more CAT activity than the ones not treated (FIG. 6). Data were transformed with square root to meet ANOVA requirements.

Activity of CAT tended to be induced by UBP products both in herbicide applied and not applied treatments. Also, UBP110 alone or in combination with UBP140 generated a significant increase of CAT antioxidant activity regardless of the herbicide application. This was more marked in the presence of UBP140. In general, plants treated with herbicide showed more CAT activity than the ones not treated. Data were transformed with square root to meet ANOVA requirements.

TABLE 7
Greenhouse Average CAT activity per treatment at V4. Different
letters show significant differences (α: 0.05; Duncan Test).

| | CAT | | | |
|---|---|---|---|---|
| | (μmols of | | | |
| | H₂O₂/ | | | |
| | minute · mg | | | |
| Treatment | of protein) | | | |
| Untreated check | 0.0175 | | | C |
| UPB 140 | 0.0196 | | B | C |
| UPB 110 | 0.0201 | | B | C |
| UBP 140 + UBP 110 | 0.0218 | | B | C |
| Herbicide | 0.0201 | | B | C |
| UBP 140 + Herbicide | 0.0221 | | B | C |
| UBP 110 + Herbicide | 0.0310 | A | | |
| UBP 140 + UBP 110 + Herbicide | 0.0329 | A | | |

Guaiacol Peroxidase (GPOX) activity was measured as the increase in absorbance at 470 nm due to the formation of tetraguaiacol (extinction coefficient=26.6 mM/cm) at 30° C. The reaction medium contained 30 μI of enzyme extract, 50 mM potassium phosphate buffer pH 7.0, 0.1 mM EDTA, 10 mM guaiacol and 10 mM H₂₀₂. Enzyme activity was expressed as μmol of tetraguaiacol/minute·mg of protein (Balestrasse et al., 2001).

Results of the GPOX analysis are shown in FIG. 7 and table 8. When herbicide was not applied, all treatments with UBP tended to reduce the oxidative stress of the crop, being UBP140+UBP110 the one with the best performance (FIG. 7). This last treatment significantly diminished stress of soybean plants compared with the control (Table 9). In the cases treated with herbicide, both UBP140, UBP110 and its combination (UBP140+UBP110) produced a significant decrease of the stress of the crop (FIG. 6, Table 9). Table 9 shows Average TSARS content per treatment at V4. Different letters show significant differences (α: 0,05; Duncan Test).

TABLE 8
Average GPOX activity per treatment at V4. Different letters
show significant differences (α: 0.05; Duncan Test).

| | GPOX | | | |
|---|---|---|---|---|
| | (μmols of | | | |
| | tetraguaiacol/ | | | |
| | minute · mg | | | |
| Treatment | of protein) | | | |
| Untreated check | 0.0047 | | | C |
| UPB 140 | 0.0063 | | | C |
| UPB 110 | 0.0100 | | B | |
| UBP 140 + UBP 110 | 0.0117 | | B | |
| Herbicide | 0.0587 | A | | |
| UBP 140 + Herbicide | 0.0608 | A | | |
| UBP 110 + Herbicide | 0.0630 | A | | |
| UBP 140 + UBP 110 + Herbicide | 0.0660 | A | | |

To measure PAL activity, first, a 50 mM TRIS-HCl Buffer pH 7.6+EDTA was prepared. Then, a solution of L-phenylalanine with Buffer TRIS-HCl was made (Assis et al., 2001). Next, 1.8 mL of the L-phenylalanine solution and 200 μl of the enzyme extract solution described above were placed in in hemolysis tubes. The tubes were incubated at 40° C. for 2 h, measuring the absorbance at 290 nm at times 0, 45, 90 and 120 minutes to obtain a slope was obtained over time. The results are expressed in μmol of Cinnamic acid/minute·mg of protein (Assis et al., 2001).

FIG. X and table X show the measured PAL activity. The stress caused by the herbicide treatment significantly enhanced PAL activity in comparison with the plants that did not have herbicide. When herbicide was applied, it seemed that the stress was so strong that the control showed the maximum PAL activity (not significant). As noted above for TSARS and the activity of antioxidant enzymes, this could be because UBP treatments generated a reduction on the negative effect of the herbicide, reducing the peak of oxidative stress generated by it. In consequence, the activity of defense enzymes such as PAL tend to be less, because there is less stress.

In absence of herbicide, it seemed UBP products tend to improve the activity of the enzyme, but this wasn't statistically significant. Data were transformed with square root to accomplish ANOVA requirements.

TABLE 9
Average PAL activity per treatment at V4. Different letters
show significant differences (α: 0.05; Duncan Test).

| | PAL | | |
|---|---|---|---|
| | (μmols of | | |
| | Cinamic acid/ | | |
| | minute · mg | | |
| Treatment | of protein) | | |
| Untreated check | 0.000115 | | B |
| UPB 140 | 0.000132 | | B |
| UPB 110 | 0.000138 | | B |
| UBP 140 + UBP 110 | 0.000146 | | B |
| Herbicide | 0.000455 | A | |
| UBP 140 + Herbicide | 0.000372 | A | |
| UBP 110 + Herbicide | 0.000331 | A | |
| UBP 140 + UBP 110 + | 0.000371 | A | |
| Herbicide | | | |

PPO activity was also measure. In a hemolysis tube, the reaction medium consisted of 1.5 ml of 0.1 M sodium phosphate buffer (pH 6.5) and 200 μL of the enzyme extract. To initiate the reaction, 200 μL of 0.1 M catechol was added to the tube and the activity was expressed as change in absorbance at 412 nm at 30 seconds intervals for 3 minutes. A molar extinction coefficient of 1010 M-1 cm-1 was used. The results are expressed as μmol of quinones/minute/mg of protein (Chen et al., 2000; Furumo and Furutani, 2008).

In the absence of herbicide, UBP140, and especially, the combination of UBP140+UBP110, increased PPO activity significantly compared with the control. When herbicide was applied, the greatest enzyme activity was shown by the control, although it wasn't significant. These results were similar to what we have seen with PAL activity.

TABLE 10
Average PPO activity per treatment at V4. Different letters
show significant differences (α: 0.05; Duncan Test).

| | PPO | | | |
|---|---|---|---|---|
| | (μmols of | | | |
| | quinones/ | | | |
| | minute · mg | | | |
| Treatment | of protein) | | | |
| Untreated check | 3.22 | | | C |
| UPB 140 | 3.81 | | B | |
| UPB 110 | 3.71 | | B | C |
| UBP 140 + UBP 110 | 4.05 | | B | |
| Herbicide | 5.14 | A | | |
| UBP 140 + Herbicide | 4.15 | A | B | |
| UBP 110 + Herbicide | 4.33 | A | B | |
| UBP 140 + UBP 110 + | 4.52 | A | B | |
| Herbicide | | | | |

The activity of β1,3 glucanase was also determined, according to El Ghaouth et al. (2002), incubating 62.5 μl of enzyme preparation for 24 h at 40° C. in 62.5 μl of 4% laminarin. The reaction was terminated by heating the sample in boiling water for 5 min and the amount of reducing sugars was measured spectrophotometrically at 500 nm after the reaction with 372 μL of 3,5-dinitrosalicylic acid (El Ghaouth et al., 2002). Enzyme activity was determined by measuring the level of production of reducing sugars (Nelson, 1944) and expressed in terms of specific activity as mg of glucose/minute·mg of protein.

β1,3 glucanase showed a similar behavior to the other defense enzymes. Even though there were no significant differences between treatments when herbicide was applied, the control with fomesafen was the one which registered a slightly greater activity than the treatments with UBP. Also, herbicide treated plants presented a significant increase of β1,3 glucanase activity in comparison with no herbicide treated plants.

UBP products showed a tendency of increasing the activity of the enzyme when herbicide was not present.

Total phenolic content was also determined. For the extraction of leaf samples for chemical analysis, one gram of leaf was ground and dissolved in 40 ml of 90% methanol. The tightly capped bottle was placed in a water bath at 80° C. temperature. After 1 h, the extract was cooled and filtered.

Total phenolic content was determined with Folin-Ciocalteu reagent according to the method of Slinkard and Singleton (1977) using gallic acid as a standard phenolic compound. 50 μl of leaf extract solution was placed in a test tube, then 1 ml of Folin-Ciocalteu reagent (previously diluted by distilled water; Reagent:Water=1:4) was added and the content was mixed thoroughly. After 3 min, 1 ml of Na2CO3 (10%) was added, and the mixture was allowed to stand for 1 h in the dark.

Absorbance was measured at 760 nm in spectrophotometer. The concentration of total phenolic compounds in leaf extracts was determined as micrograms of gallic acid equivalent using an equation obtained from a standard gallic acid graph. Results are expressed as mg/100 g gallic acid equivalent (GAE) of fresh weight.

The data for total phenolic compounds at V4 seems to suggest that the stress that herbicide generated was so strong, it triggered an important accumulation of phenolic compounds. The addition of UBP products in herbicide treated plants, decreased significantly the phenolic content of the crop, especially with the combination of UBP140+UBP110. This corresponds with the activity of PAL which is a precursor of these compounds.

In absence of herbicide, all UBP treatments significantly increased the phenolic content of soybean at V4. FIG. X shows the average phenolic compound content in Soybean foliar tissue per treatment at V4.

TABLE 11
Average phenolic content per treatment at V4. Different letters
show significant differences (α: 0.05; Duncan Test).

| | Total Phenolic Compounds | | | | | |
|---|---|---|---|---|---|---|
| Treatment | (mg/100 g GAE*) | | | | | |
| Untreated check | 0.099 | | | | | E |
| UPB 140 | 0.116 | | | | D | |
| UPB 110 | 0.119 | | | | D | |
| UBP 140 + UBP 110 | 0.125 | | | | D | |
| Herbicide | 0.320 | A | | | | |
| UBP 140 + Herbicide | 0.291 | | B | | | |
| UBP 110 + Herbicide | 0.286 | | B | | | |
| UBP 140 + UBP 110 + Herbicide | 0.222 | | | C | | |

Total phenolic compounds at Tl show all treatments tended to pair. A slight trend was observed for UBP treatments to enhance the phenolic content, but there were no significant differences between treatments neither in presence or absence of herbicide.

TABLE 12
Average phenolic content per treatment at R1. Different letters
show significant differences (α: 0.05; Duncan Test).

| | Total | |
|---|---|---|
| | Phenolic Compounds | |
| Treatment | (mg/100 g GAE*) | |
| Untreated check | 0.139 | A |
| UPB 140 | 0.150 | A |
| UPB 110 | 0.144 | A |
| UBP 140 + UBP 110 | 0.141 | A |
| Herbicide | 0.126 | A |
| UBP 140 + Herbicide | 0.143 | A |
| UBP 110 + Herbicide | 0.133 | A |
| UBP 140 + UBP 110 + | 0.152 | A |
| Herbicide | | |

*GAE: Gallic Acid Equivalents.

Chlorophyll content was also determined. First, a portion of foliar tissue sample (0.5 g) was homogenized in 15 ml of 96° Ethanol. The extracts were placed in a hot bath until the leaves were blanched. After centrifugation of the extracts, the absorbance was determined at 665, 649 and 654 nm as described by Wintermans and de Mots (1965).

When the plants were exposed to the herbicide, its Chlorophyll content tended to reduce, particularly when they weren't treated with UBP products. In this sense, UBP140, both alone and in combination with UBP110, proved to raise total chlorophyll content of herbicide treated plants significantly vs. the control.

When the plants weren't applied with fomesafen, the combo of UBP140+UBP110 showed the best performance at increasing Chlorophyll content. Nevertheless, this was not significant.

TABLE 13
Average chlorophyll content per treatment at V4. Different
letters show significant differences (α: 0.05; Duncan Test).

| | Chlorophyll content | | | |
|---|---|---|---|---|
| | (mg of chlorophyll/ | | | |
| Treatment | g fresh weight) | | | |
| Untreated check | 3.18 | A | B | |
| UPB 140 | 3.38 | A | B | |
| UPB 110 | 3.28 | A | B | |
| UBP 140 + UBP 110 | 3.67 | A | | |
| Herbicide | 2.41 | | | C |
| UBP 140 + Herbicide | 3.23 | A | B | |
| UBP 110 + Herbicide | 2.92 | | B | C |
| UBP 140 + UBP 110 + | 3.41 | A | B | |
| Herbicide | | | | |

All the variables were analyzed through AN OVA or Non-Parametric ANOVA (Kruskal-Wallis) and multiple comparison test Duncan using the statistical program “Infostat.”

### Study 2 Results (Herbicide Stress Reduction on Soybean Grown in Field)

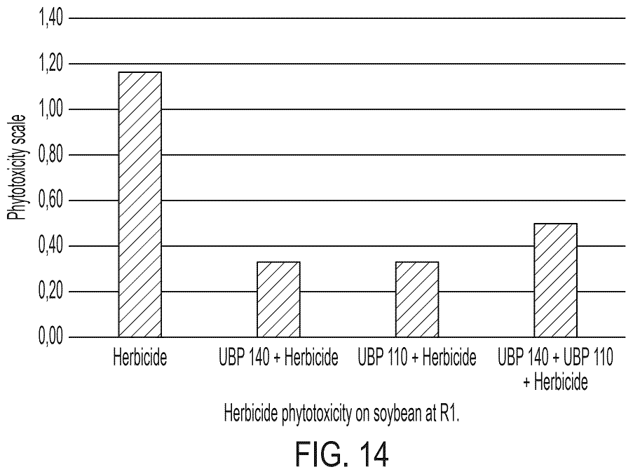

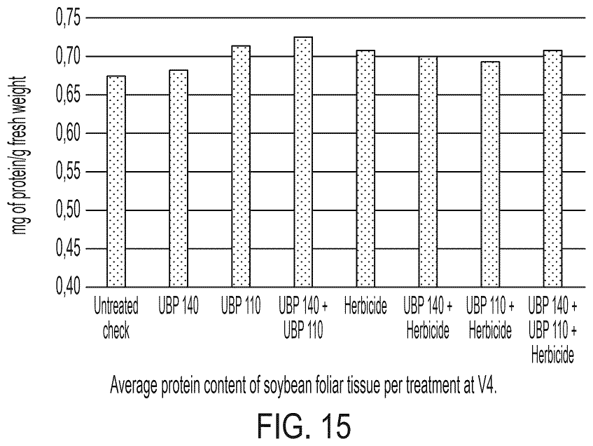

This study was similar to Study 1, but was conducted in the field rather than in a greenhouse. Phytotoxicity was measured, and both UBP140, UBP110 and its combination proved to diminish herbicide phytotoxicity on soybean significantly, at R1, two weeks after herbicide application (FIG. 14, Table 14).

TABLE 14
Average phytotoxicity level on soybean per treatment at R1. Different
letters show significant differences (α: 0.05; Duncan Test).

| Treatment | Phytotoxicity | | |
|---|---|---|---|
| Herbicide | 1.17 | A | |
| UBP 140 + Herbicide | 0.33 | | B |
| UBP 110 + Herbicide | 0.33 | | B |
| UBP 140 + UBP 110 + | 0.50 | | B |
| Herbicide | | | |

Total proteins were also measured, similar to the details described above. There were no significant differences between treatments.

When the plants were not applied with herbicide, treatments that contained UBP110 tended to increase the protein content of the plants. In presence of the herbicide there was not a clear trend. It seems that the stress caused by the herbicide generated the expression of a battery of proteins related to defense and the fighting against stress in the plant.

TABLE 15
Average protein content per treatment at R1. Different letters
show significant differences (α: 0.05; Duncan Test).

| | Protein Content | |
|---|---|---|
| | (mg of protein/g | |
| Treatment | fresh weight) | |
| Untreated check | 0.67 | A |
| UPB 140 | 0.68 | A |
| UPB 110 | 0.71 | A |
| UBP 140 + UBP 110 | 0.72 | A |
| Herbicide | 0.71 | A |
| UBP 140 + Herbicide | 0.70 | A |
| UBP 110 + Herbicide | 0.69 | A |
| UBP 140 + UBP 110 + | 0.71 | A |
| Herbicide | | |

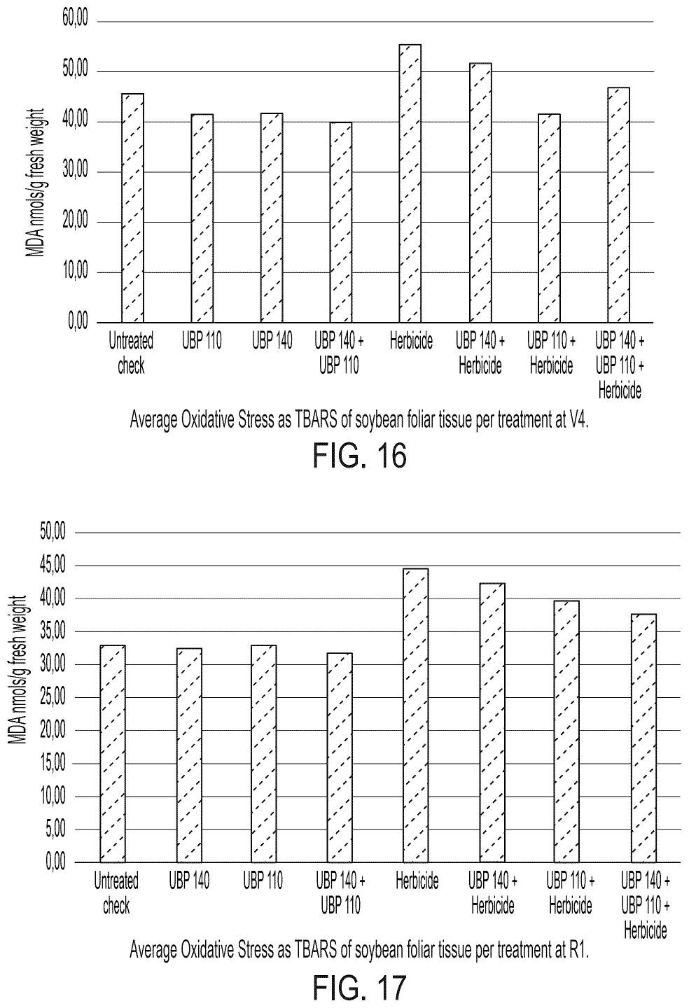

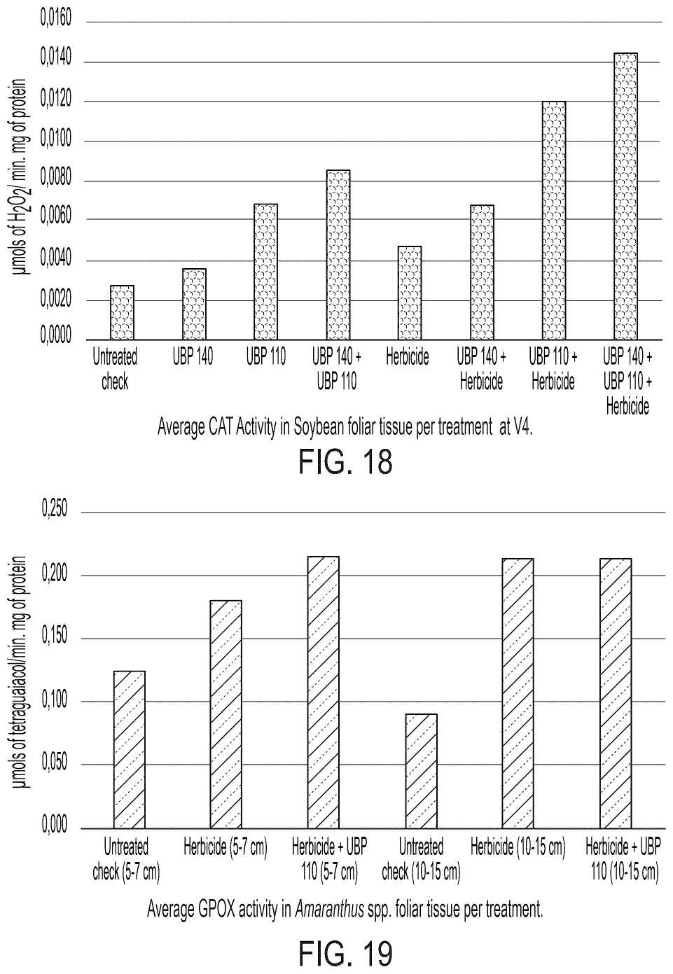

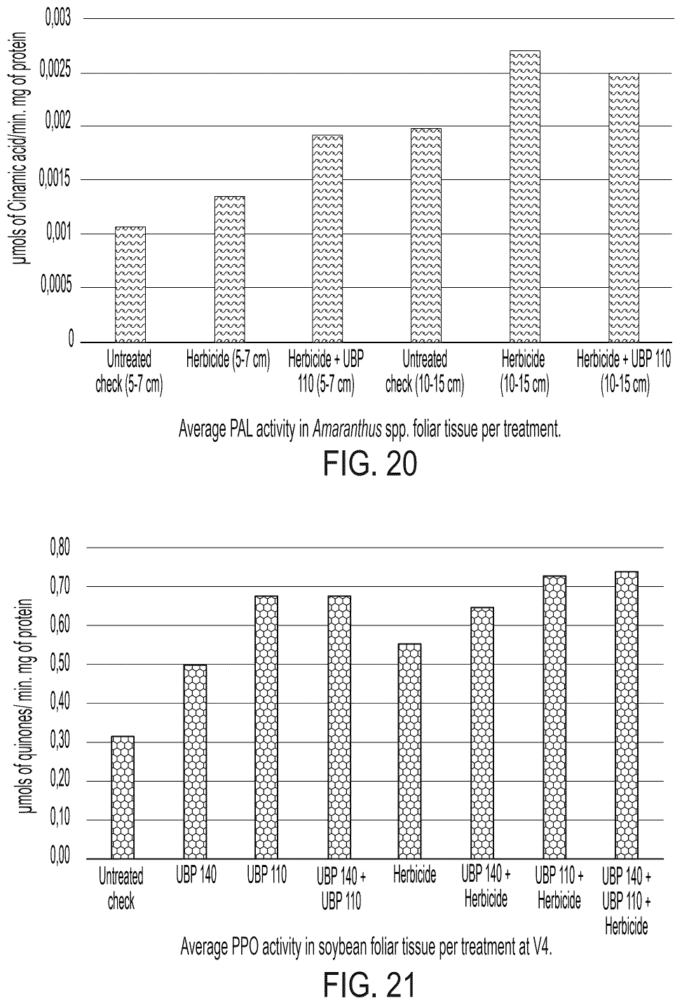

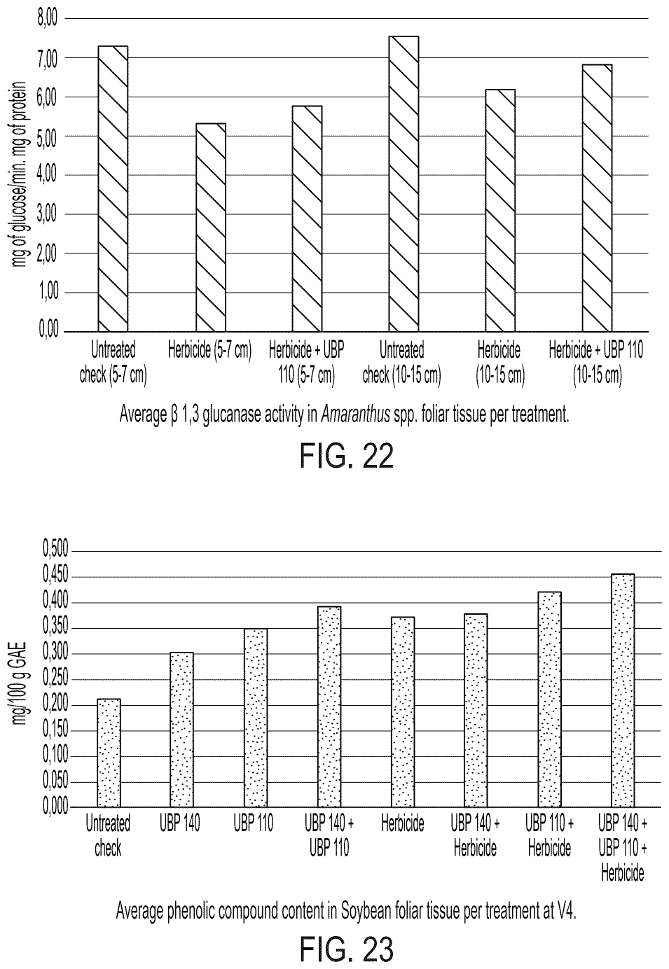

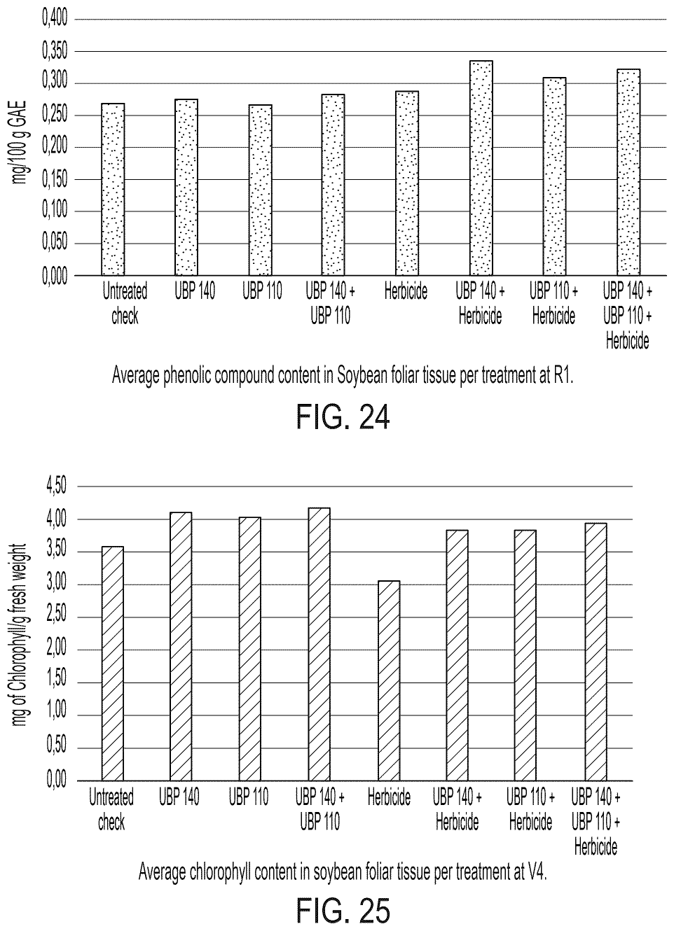

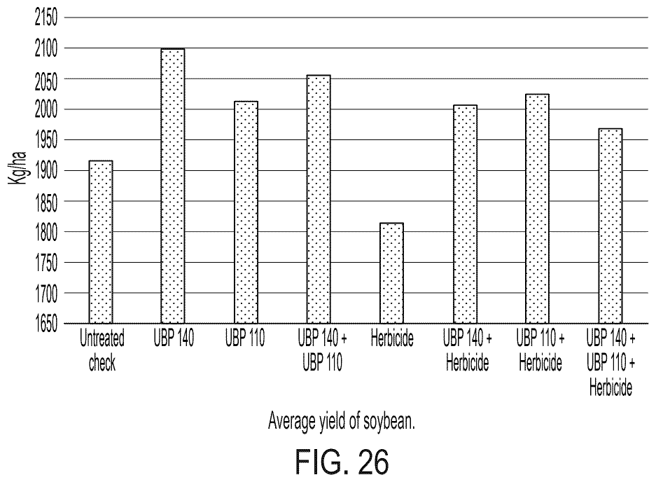

TBARS was also measured, at V4 and again at R1 (FIGS. 16-17). At V4, when herbicide was not applied, all treatments with UBP tended to reduce the oxidative stress of the crop, being UBP140+UBP110 the one with the best performance. However, the differences between these treatments were not significant. In the cases treated with herbicide, UBP110 and its combination with UBP140 produced a significant decrease of the stress of the crop compared with the control treated with herbicide. Data were transformed with LN to accomplish ANOVA requirements.

TABLE 16
Average TBARS content per treatment at R1. Different letters
show significant differences (α: 0.05; Duncan Test).

| | TBARS | | | |
|---|---|---|---|---|
| | (MDA nmols/g | | | |
| Treatment | fresh weight) | | | |
| Untreated check | 45.63 | | B | C |
| UBP 140 | 41.58 | | | C |
| UBP 110 | 41.65 | | | C |
| UBP 140 + UBP 110 | 39.82 | | | C |
| Herbicide | 55.44 | A | | |
| UBP 140 + Herbicide | 51.71 | A | B | |
| UBP 110 + Herbicide | 41.48 | | | C |
| UBP 140 + UBP 110 + | 46.97 | | B | C |
| Herbicide | | | | |

The increase of the oxidative stress of the crop due to herbicide application was significant even two weeks after the treatment application. Treatments with UBP tended to reduce the oxidative stress of the crop when herbicide was present, UBP140+UBP110 having the one with the best performance.

Data were transformed with LN to accomplish ANOVA requirements.

TABLE 17
Average TBARS per treatment at R1. Different letters
show significant differences (α: 0.05; Duncan Test).

| | TBARS | | |
|---|---|---|---|
| | (MDA nmols/g | | |
| Treatment | fresh weight) | | |
| Untreated check | 32.90 | | B |
| UBP 140 | 32.52 | | B |
| UBP 110 | 32.99 | | B |
| UBP 140 + UBP 110 | 31.68 | | B |
| Herbicide | 44.52 | A | |
| UBP 140 + Herbicide | 42.20 | A | |
| UBP 110 + Herbicide | 39.57 | A | |
| UBP 140 + UBP 110 + | 37.72 | A | |
| Herbicide | | | |

The activity of CAT was also measured, like the techniques listed above for greenhouse. CAT tended to be induced by UBP products both in herbicide applied and not applied treatments. Also, UBP110 alone or in combination with UBP140 generated a significant increase of CAT antioxidant activity regardless of the herbicide application. This was more marked in the presence of UBP140. In general, plants treated with herbicide showed more CAT activity than the ones not treated. Data were transformed with square root to meet ANOVA requirements.

TABLE 18
Average CAT activity per treatment at V4. Different letters
show significant differences (α: 0.05; Duncan Test).

| | CAT | | | |
|---|---|---|---|---|
| | (μmols of | | | |
| | H₂O₂/ | | | |
| | minute · mg | | | |
| Treatment | of protein) | | | |
| Untreated check | 0.0028 | | | C |
| UBP 140 | 0.0036 | | B | C |
| UBP 110 | 0.0068 | A | B | |
| UBP 140 + UBP 110 | 0.0085 | A | B | |
| Herbicide | 0.0047 | | B | C |
| UBP 140 + Herbicide | 0.0068 | A | B | C |
| UBP 110 + Herbicide | 0.0120 | A | B | |
| UBP 140 + UBP 110 + | 0.0144 | A | | |
| Herbicide | | | | |

GPOX activity was also measured. All the treatments that contained UBP products tended to increase the activity of GPOX vs the controls in herbicide applied and not applied plants. UBP110 was the one that showed the greater induction of GPOX. However, there were no significant differences between treatments. Plants treated with herbicide showed more GPOX activity than the ones not treated. Data were transformed with LN to meet ANOVA requirements.

TABLE 19
Average GPOX activity per treatment at V4. Different letters
show significant differences (α: 0.05; Duncan Test).

| | GPOX | |
|---|---|---|
| | (μmols of | |
| | tetraguaiacol/ | |
| | minute · mg | |
| Treatment | of protein) | |
| Untreated check | 0.075 | A |
| UBP 140 | 0.077 | A |
| UBP 110 | 0.104 | A |
| UBP 140 + UBP 110 | 0.098 | A |
| Herbicide | 0.125 | A |
| UBP 140 + Herbicide | 0.129 | A |
| UBP 110 + Herbicide | 0.139 | A |
| UBP 140 + UBP 110 + | 0.131 | A |
| Herbicide | | |

PAL activity was also measured. The stress caused by the herbicide tended to enhance PAL activity in comparison with the plants that did not have herbicide application. UBP treatments tended to induce PAL activity regardless herbicide application. This was more noticeable when UBP110, alone or combined with UBP140, was applied. These treatments (UBP110, UBP140+UBP110) increased PAL activity significantly compared with the control in absence of herbicide. When herbicide was present, UBP110 showed the greater induction of PAL significantly.

TABLE 20
Average PAL activity per treatment at V4. Different letters
show significant differences (α: 0.05; Duncan Test).

| | PAL | | | | |
|---|---|---|---|---|---|
| | (μmols of | | | | |
| | Cinnamic acid/ | | | | |
| | minute · mg | | | | |
| Treatment | of protein) | | | | |
| Untreated check | 0.00051 | | | | D |
| UBP 140 | 0.00083 | | | | D |
| UBP 110 | 0.00146 | | | C | |
| UBP 140 + UBP 110 | 0.00159 | | | C | |
| Herbicide | 0.00190 | | B | C | |
| UBP 140 + Herbicide | 0.00194 | | B | C | |
| UBP 110 + Herbicide | 0.00252 | A | | | |
| UBP 140 + UBP 110 + | 0.00228 | A | B | | |
| Herbicide | | | | | |

PPO activity was also measured. UBP treatments tended to induce PPO activity both in herbicide treated and not treated plants. Treatments containing UBP110 (UBP110 and UBP110+UBP140) improved PPO activity significantly compared with the controls, regardless of herbicide application. This is similar to what was seen with PAL activity. Data were transformed with LN to accomplish ANOVA requirements.

TABLE 21
Average PPO activity per treatment at V4. Different letters
show significant differences (α: 0.05; Duncan Test).

| | PPO | | | |
|---|---|---|---|---|
| | (μmols of | | | |
| | quinones/ | | | |
| | minute · mg | | | |
| Treatment | of protein) | | | |
| Untreated check | 0.32 | | | C |
| UBP 140 | 0.50 | | B | C |
| UBP 110 | 0.68 | A | B | |
| UBP 140 + UBP 110 | 0.68 | A | B | |
| Herbicide | 0.56 | | B | |
| UBP 140 + Herbicide | 0.65 | A | B | |
| UBP 110 + Herbicide | 0.73 | A | | |
| UBP 140 + UBP 110 + | 0.74 | A | | |
| Herbicide | | | | |

The activity of β1,3 glucanase was also measured, similar to the methods described above with respect to crops frown in the greenhouse. The activity of β1,3 glucanase tended to increase when UBP treatments were applied, both in presence or absence of the herbicide. As seen with the other defense enzymes analyzed before, the induction was more marked when UBP110 (alone or integrated with UBP140) was applied. Nevertheless, the differences between treatments weren't significant.

TABLE 22
Average β 1.3 glucanase activity per treatment at V4. Different
letters show significant differences (α: 0.05; Duncan Test).

| | β 1.3 glucanase | |
|---|---|---|
| | (mg of glucose/ | |
| | minute · mg | |
| Treatment | of protein) | |
| Untreated check | 2.13 | A |
| UBP 140 | 2.21 | A |
| UBP 110 | 2.39 | A |
| UBP 140 + UBP 110 | 2.36 | A |
| Herbicide | 2.32 | A |
| UBP 140 + Herbicide | 2.32 | A |
| UBP 110 + Herbicide | 2.53 | A |
| UBP 140 + UBP 110 + | 2.54 | A |
| Herbicide | | |

Total phenolic compounds was also measured at V4 and R1. At V4, all treatments with UBP showed a trend to increase the phenolic content of the crop, both in herbicide applied and not applied plants. In the absence of herbicide, UBP140, UBP110 and the integrated application of both, showed a significant gain of the phenolic content. When herbicide was applied, the trend was maintained, but there were no significant differences between treatments. Data were transformed with LN to accomplish ANOVA requirements.

TABLE 23
Average phenolic content per treatment at V4. Different letters
show significant differences (α: 0.05; Duncan Test)

| | Total | | | | |
|---|---|---|---|---|---|
| | Phenolic Compounds | | | | |
| Treatment | (mg/100 g GAE*) | | | | |
| Untreated check | 0.211 | | | | D |
| UBP 140 | 0.303 | | | C | |
| UBP 110 | 0.348 | | B | C | |
| UBP 140 + UBP 110 | 0.392 | A | B | | |
| Herbicide | 0.371 | A | B | | |
| UBP 140 + Herbicide | 0.377 | A | B | | |
| UBP 110 + Herbicide | 0.420 | A | B | | |
| UBP 140 + UBP 110 + | 0.456 | A | | | |
| Herbicide | | | | | |

*GAE: Gallic acid equivalents

At R1, the treatments tended to even. The application of UBP products tended to enhance the phenolic content, but there were no significant differences between treatments (Table 24).

TABLE 24
Average phenolic content per treatment at R1. Different letters
show significant differences (α: 0.05; Duncan Test)

| | Total | |
|---|---|---|
| | Phenolic Compounds | |
| Treatment | (mg/100 g GAE*) | |
| Untreated check | 0.269 | A |
| UBP 140 | 0.278 | A |
| UBP 110 | 0.266 | A |
| UBP 140 + UBP 110 | 0.282 | A |
| Herbicide | 0.288 | A |
| UBP 140 + Herbicide | 0.337 | A |
| UBP 110 + Herbicide | 0.311 | A |
| UBP 140 + UBP 110 + | 0.323 | A |
| Herbicide | | |

*GAE: Gallic acid equivalents.

Chlorophyll content was also measured, similar to the methods detailed above. The application of the herbicide diminished soybean's chlorophyll content. However, with both UBP140, UBP110 or its combination, the chlorophyll content of the herbicide-treated soybeans did not differ significantly from the controls.

TABLE 25
Average chlorophyll content per treatment at V4. Different
letters show significant differences (α: 0.05; Duncan Test)

| | Chlorophyll content | | |
|---|---|---|---|
| | (mg of chlorophyll/ | | |
| Treatment | g fresh weight) | | |
| Untreated check | 3.59 | A | |
| UBP 140 | 4.11 | A | |
| UBP 110 | 4.03 | A | |
| UBP 140 + UBP 110 | 4.17 | A | |
| Herbicide | 3.06 | | B |
| UBP 140 + Herbicide | 3.83 | A | |
| UBP 110 + Herbicide | 3.83 | A | |
| UBP 140 + UBP 110 + | 3.96 | A | |
| Herbicide | | | |

Yield was also measured. When the plants were exposed to the herbicide, all treatments containing UBP showed a significant increase of yield compared to the control. In this case, there were no significant differences between UBP treatments. In the absence of herbicide application, although all UBP treatments tended to rise yield, only UBP140 differed significantly from the control.

TABLE 26
Average yield of soybean per treatment. Different letters
show significant differences (α: 0.05; Duncan Test)

| | Yield (Kg | | | |
|---|---|---|---|---|
| | of soybean | | | |
| Treatment | grain/ha)* | | | |
| Untreated check | 1916 | | B | C |
| UBP 140 | 2098 | A | | |
| UBP 110 | 2013 | A | B | |
| UBP 140 + UBP 110 | 2056 | A | B | |
| Herbicide | 1815 | | | C |
| UBP 140 + Herbicide | 2007 | A | B | |
| UBP 110 + Herbicide | 2024 | A | B | |
| UBP 140 + UBP 110 + | 1969 | A | B | |
| Herbicide | | | | |

In general, this study shows treatments that contained UBP140 increased seedling emergence significantly and tended to slightly improve vigor compared with the control. UBP treatments proved to diminish herbicide phytotoxicity on soybean significantly at R1. UBP110 and its combination with UBP140 produced a significant decrease of the stress of plants applied with herbicide and tended to reduce the oxidative stress of not applied plants, both at V4 and R1. UBP110 alone or in combination with UBP140 generated a significant increase of CAT antioxidant activity regardless of the herbicide application. Also tended to increase the activity of GPOX vs the controls. Treatments that contained UBP110 (UBP110 and UBP110+UBP140) improved PAL and PPO defense activity significantly compared with the controls. The activity of β1,3 glucanase tended to increase when UBP treatments were applied, especially with UBP110. Differences between treatments were not significant. Treatments with UBP showed a trend to increase the phenolic content of the crop at V4 and R1. The application of the herbicide diminished Soybean's chlorophyll content but with both UBP140, UBP110 or its combination, the chlorophyll content of the herbicide-treated soybeans did not differ significantly from the controls. UBP treatments increased yield significantly when compared to the control when herbicide was applied. Without herbicide, although all UBP treatments tended to rise yield, only UBP140 differed significantly from the control.

Study 3. Herbicide Stress Reduction on Amaranthus ssp. Grown in Greenhouse

Amaranthus spp. has several characteristics that makes it a dominant and hard to control weed. One of the issues that soybean production faces and cause diminish of yield are weeds, such as Amaranthus spp. Resistance to several herbicides is probably the most important problem with this specie. Protox enzyme inhibitors can be useful in the management of this weed. However, when used on soybean, phytotoxicity issues regarding these herbicides may appear. Biostimulants like UBP110 could be used as help to improve plant metabolism, counteract phytotoxicity effects, and improve yield. But this decrease in oxidative stress given by biostimulants could also impact the herbicide's biocidal effect on weeds. The purpose of this study was to analyze the effects of UBP110 on the efficacy of control of fomesafen herbicide on Amaranthus spp. and the variation of the plant's oxidative stress and defense enzymatic activity.

For this, a trial in pots in greenhouse with two weed sizes (5-7 cm and 10-15 cm) was carried out. The level of oxidative stress (TBARS) and the activity of antioxidant and defense related enzymes (CAT, GPOX, PAL, PPO and β1,3 glucanase) were analyzed. Besides that, the chlorophyll and phenolic content were determined. Also, the weed control and aerial and radical biomass were measured. It was determined that the herbicide mixture with UBP110 tended to reduce oxidative stress of Amaranthus spp. compared with the herbicide alone. Also, it tended to increase PPO activity. Finally, it tended to increase the content of phenolic compounds when weeds were small and the Chlorophyll content at both weed's sizes. However, the addition of UBP110 to the herbicide tank mixture did not affect the loss of aerial and radical weed biomass generated by the herbicide. Neither its control efficacy.

The arrangement of the trial was carried out in a Complete randomized Design. Amaranthus spp. plants were grown in pots in a greenhouse. The treatments were the following:

TABLE 27
Treatments of Amaranthus ssp.

| | | | Application | |
|---|---|---|---|---|
| Treat. no | Product | Dose | time/sampling | |
| 1 | Untreated check | — | 5-7 | cm |
| 2 | Herbicide* | 1 L/ha | 5-7 | cm |
| 3 | Herbicide + UBP110 | 1 L/ha + | 5-7 | cm |
| | | 150 g/ha | | |
| 4 | Untreated check | — | 10-15 | cm |
| 5 | Herbicide | 1 L/ha | 10-15 | cm |
| 6 | Herbicide + UBP110 | 1 L/ha + | 10-15 | cm |
| | | 150 g/ha | | |

The pots were filled with soil of the locality of San Pedro (Buenos Aires Province). Six replicates were made per treatment. The seeds were obtained from wild Amaranthus spp. resistant to glyphosate, growing on the field. The date of sowing was Jan. 13, 2020 (higher size) and Jan. 17, 2020 (smaller size). Plants were irrigated and maintained at field capacity throughout the trial. The pots were rotated daily to avoid differentiated effects due to the intensity and quality of light. The average temperature during the course of the test was 28° C. The doses and time of application of the treatments are detailed in Table 27. The treatments were applied with a backpack of carbon dioxide gas at 2 bars of pressure at a rate of 4.5 km/h. The application volume was 110 L/ha.

Control and wet matter production (aerial and radical biomass) were measured 10 days after treatment application. Oxidative Stress, antioxidant and defense enzyme activity were analyzed 48 h after herbicide and UBP110 application. The herbicide used was “Flex” by the Company Syngenta, containing 25 g of fomesafen/100 cm³, formulated as a Soluble Concentrate. Dosage of the herbicide is shown in Table 27.

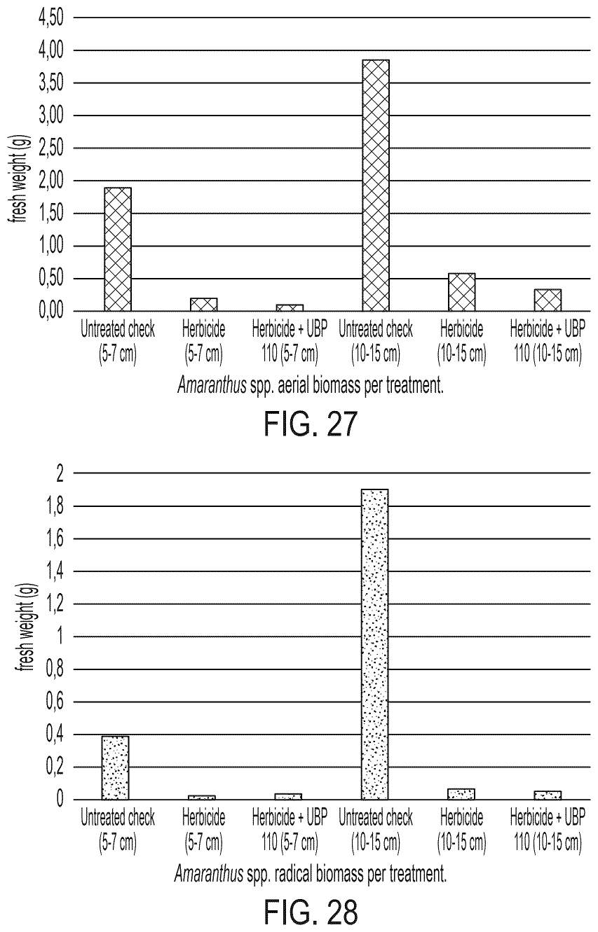

Aerial biomass data is shown in FIG. 27 and Table 28. As it was expected, when fomesafen was applied, Amaranthus spp. aerial biomass was significantly reduced both in 5-7 cm and in 10-15 cm plants (FIG. 1, Table 2). There were no significant differences between the application of herbicide alone or in combination with UBP110 at any of the weed sizes tested (Table 2).

TABLE 28
Average Amaranthus spp. aerial biomass per treatment. Different
letters show significant differences (α: 0.05; Duncan Test)

| | Aerial | | | |
|---|---|---|---|---|
| | Biomass | | | |
| Treatment | (g) | | | |
| Untreated check (5-7 cm) | 1.89 | | B | |
| Herbicide (5-7 cm) | 0.19 | | | C |
| Herbicide + UBP (5-7 cm) | 0.09 | | | C |
| Untreated check (10-15 cm) | 3.86 | A | | |
| Herbicide (10-15 cm) | 0.58 | | | C |
| Herbicide + UBP (10-15 cm) | 0.34 | | | C |

With respect to radical biomass, as with aerial biomass, when herbicide was applied, Amaranthus spp. aerial biomass was significantly reduced at both weed sizes tested (FIG. 28, Table 29). Again, as seen for the aerial part of the weed, there were no significant differences between herbicide and herbicide+UBP110 at any of the sizes tested (Table 29).

TABLE 29
Average Amaranthus spp. Radical biomass per treatment. Different
letters show significant differences (α: 0.05; Duncan Test)

| | Radical | | | |
|---|---|---|---|---|
| | Biomass | | | |
| Treatment | (g) | | | |
| Untreated check (5-7 cm) | 0.39 | | B | |
| Herbicide (5-7 cm) | 0.02 | | | C |
| Herbicide + UBP (5-7 cm) | 0.03 | | | C |
| Untreated check (10-15 cm) | 1.90 | A | | |
| Herbicide (10-15 cm) | 0.06 | | | C |
| Herbicide + UBP (10-15 cm) | 0.05 | | | C |

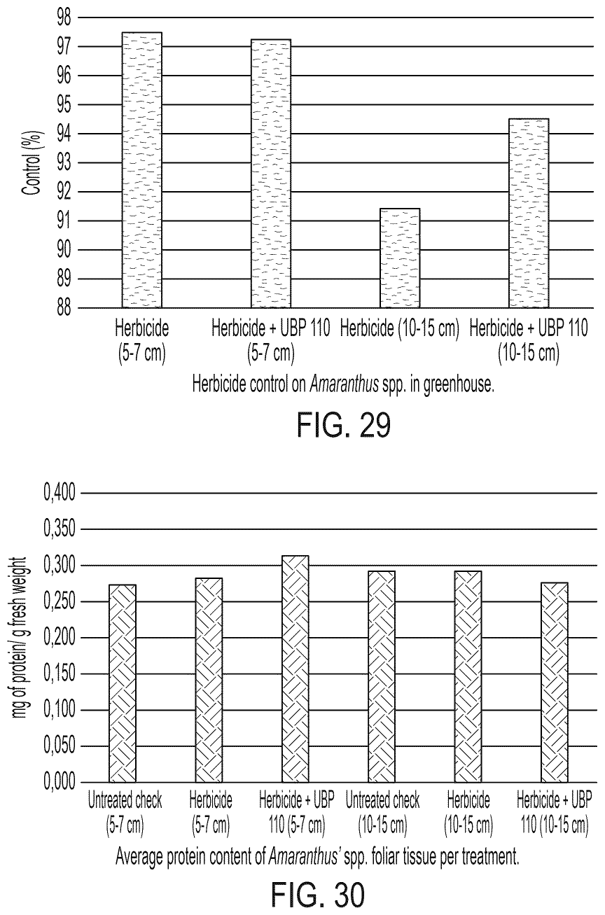

Regarding herbicide control, there were no significant differences between treatments, nor at 5-7 cm nor at 10-15 cm (Table 30). Nevertheless, when weeds where about 10-15 cm of size, the efficacy of control of the herbicide tended to decrease, especially in absence of UBP110 (FIG. 29).

TABLE 30
Average herbicide control (%) on Amaranthus spp.
per treatment. Different letters show significant
differences (α: 0.05; Kruskal-Wallis Test)

| Treatment | Control (%) | |
|---|---|---|
| Herbicide (5-7 cm) | 97.5 | A |
| Herbicide + UBP 110 (5-7 cm) | 97.2 | A |
| Herbicide (10-15 cm) | 91.4 | A |
| Herbicide + UBP 110 (10-15 cm) | 94.5 | A |

Total protein measurement was carried out according to Bradford, as described above. Although there were no significant differences on the protein content between treatments at any size of the weed (Table 31), when the plants were about 5-7 cm tall, there was a slight tendency of increasing the protein content in herbicide treatments, especially with UBP110 (FIG. 30). This could be due to the oxidative burst caused by the stress produced by the herbicide and the induction of antioxidant and defense enzymes.

TABLE 31
Average protein content of Amaranthus spp. per treatment. Different
letters show significant differences (α: 0.05; Kruskal-Wallis Test)

| | Protein Content | |
|---|---|---|
| | (mg of protein/g | |
| Treatment | fresh weight) | |
| Untreated check (5-7 cm) | 0.274 | A |
| Herbicide (5-7 cm) | 0.283 | A |
| Herbicide + UBP 110 (5-7 cm) | 0.313 | A |
| Untreated check (10-15 cm) | 0.292 | A |
| Herbicide (10-15 cm) | 0.293 | A |
| Herbicide + UBP 110 (10-15 cm) | 0.277 | A |

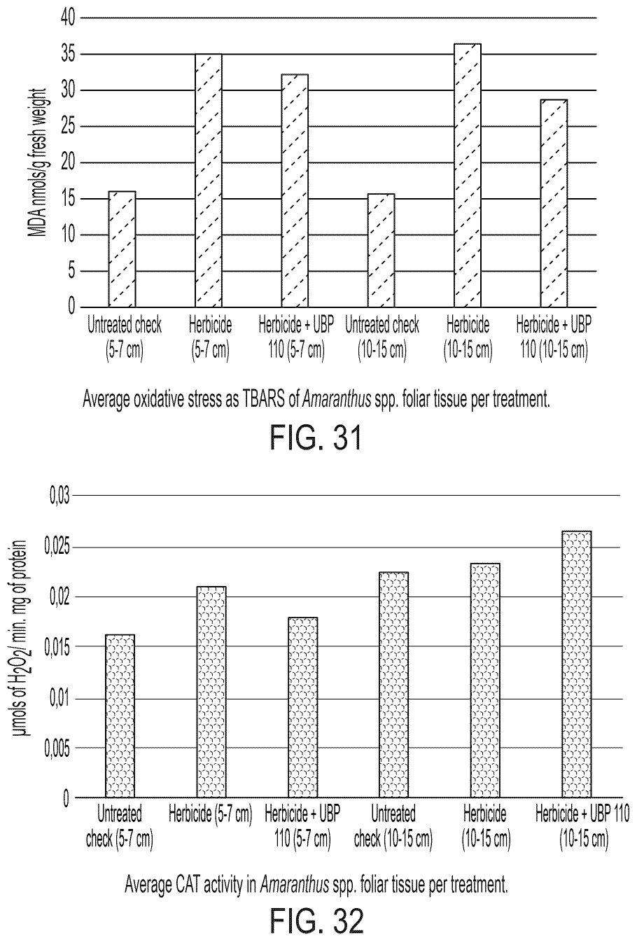

Oxidative stress determination was measured by TBARS in a similar manner described above with respect to the soybean study and the results are shown in FIG. 31 and Table 32. As expected, herbicide increase oxidative stress of Amaranthus spp. significantly. This was independent of the size in which the herbicide was applied. The addition of UBP110 to the herbicide tank mixture did not affect significantly the stress levels generated by the herbicide on the weed, in any of the sizes tested (Table 32). However, tended to slightly reduce stress (FIG. 31).

TABLE 32
Average TBARS content of Amaranthus spp. per treatment. Different
letters show significant differences (α: 0.05; Kruskal-Wallis Test)

| | TBARS | | |
|---|---|---|---|
| | (MDA nmols/g | | |
| Treatment | fresh weight) | | |
| Untreated check (5-7 cm) | 15.88 | | B |
| Herbicide (5-7 cm) | 34.97 | A | |
| Herbicide + UBP 110 (5-7 cm) | 32.14 | A | |
| Untreated check (10-15 cm) | 15.53 | | B |
| Herbicide (10-15 cm) | 36.39 | A | |
| Herbicide + UBP 110 (10-15 cm) | 28.71 | A | |

CAT activity was measured in a similar manner described above with respect to the soybean study and the results are shown in FIG. 32 and Table 33. There were no significant differences between treatments regarding CAT activity, at any of the weed sizes tested (Table 33). When weeds were 5-7 cm, the herbicide alone showed the highest CAT activity (FIG. 32). Instead, when the plants were bigger, UBP110 showed the greatest activity of the enzyme.

TABLE 33
Average CAT activity of Amaranthus spp. per treatment. Different
letters show significant differences (α: 0.05; Duncan Test)

| | CAT | |
|---|---|---|
| | (μmols of | |
| | H₂O₂/ | |
| | minute · mg | |
| Treatment | of protein) | |
| Untreated check (5-7 cm) | 0.016 | A |
| Herbicide (5-7 cm) | 0.021 | A |
| Herbicide + UBP 110 (5-7 cm) | 0.018 | A |
| Untreated check (10-15 cm) | 0.022 | A |
| Herbicide (10-15 cm) | 0.023 | A |
| Herbicide + UBP 110 (10-15 cm) | 0.027 | A |

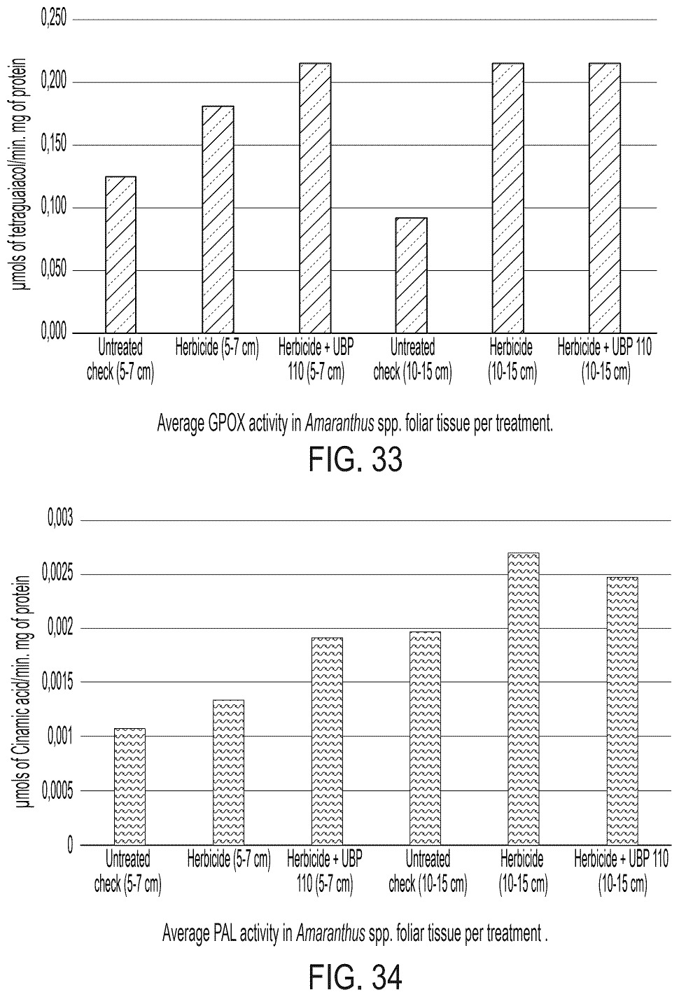

GPOX activity was measured in a similar manner described above with respect to the soybean study and the results are shown in FIG. 33 and Table 34. The oxidative stress burst caused by the herbicide, induced GPOX antioxidant activity significantly (FIG. 7, Table 8). When weeds were 5-7 cm tall, the herbicide mixture with UBP110 tended to increase the activity of GPOX more than the herbicide alone (FIG. 33). Though, differences weren't statistically significant (Table 34).

TABLE 34
Average GPOX activity of Amaranthus spp. per treatment. Different
letters show significant differences (α: 0.05; Duncan Test)

| | GPOX | | |
|---|---|---|---|
| | (μmols of | | |
| | tetraguaiacol/ | | |
| | minute · mg | | |
| Treatment | of protein) | | |
| Untreated check (5-7 cm) | 0.124 | | B |
| Herbicide (5-7 cm) | 0.179 | A | B |
| Herbicide + UBP 110 (5-7 cm) | 0.214 | A | |
| Untreated check (10-15 cm) | 0.091 | | B |
| Herbicide (10-15 cm) | 0.213 | A | |

| | | |
|---|---|---|
| Herbicide + UBP 110 (10-15 cm) | 0.213 | A |

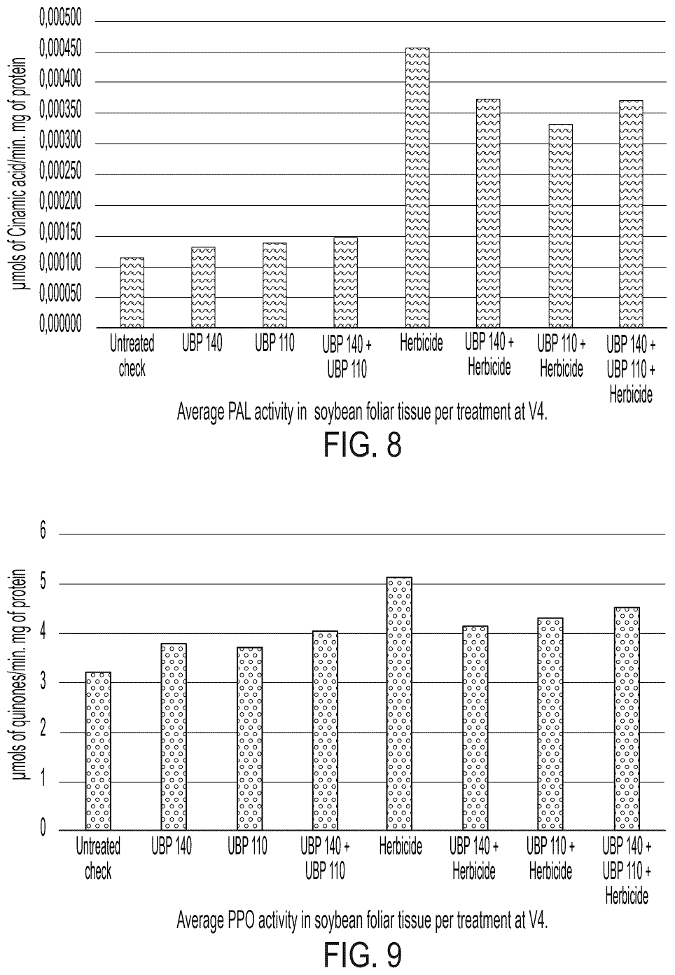

PAL activity was measured in a similar manner described above with respect to the soybean study and the results are shown in FIG. 34 and Table 35. Treatments that contained herbicide tended to increase PAL activity at initial and more advanced stages of the weed (FIG. 8). Nevertheless, there were no significant differences among treatments (Table 9). When plants were 5-7 cm, the mixture of UBP110 with the herbicide tended to slightly induce PAL activity. At 10-15 cm the herbicide alone showed the highest enzyme activity.

TABLE 35
Average PAL activity of Amaranthus spp. per treatment. Different
letters show significant differences (α: 0.05; Kruskal-Wallis Test)

| | PAL | |
|---|---|---|
| | (μmols of Cinamic | |
| | acid/minute · mg | |
| Treatment | of protein) | |
| Untreated check (5-7 cm) | 0.00107 | A |
| Herbicide (5-7 cm) | 0.00134 | A |
| Herbicide + UBP 110 (5-7 cm) | 0.00191 | A |
| Untreated check (10-15 cm) | 0.00197 | A |
| Herbicide (10-15 cm) | 0.00270 | A |
| Herbicide + UBP 110 (10-15 cm) | 0.00248 | A |

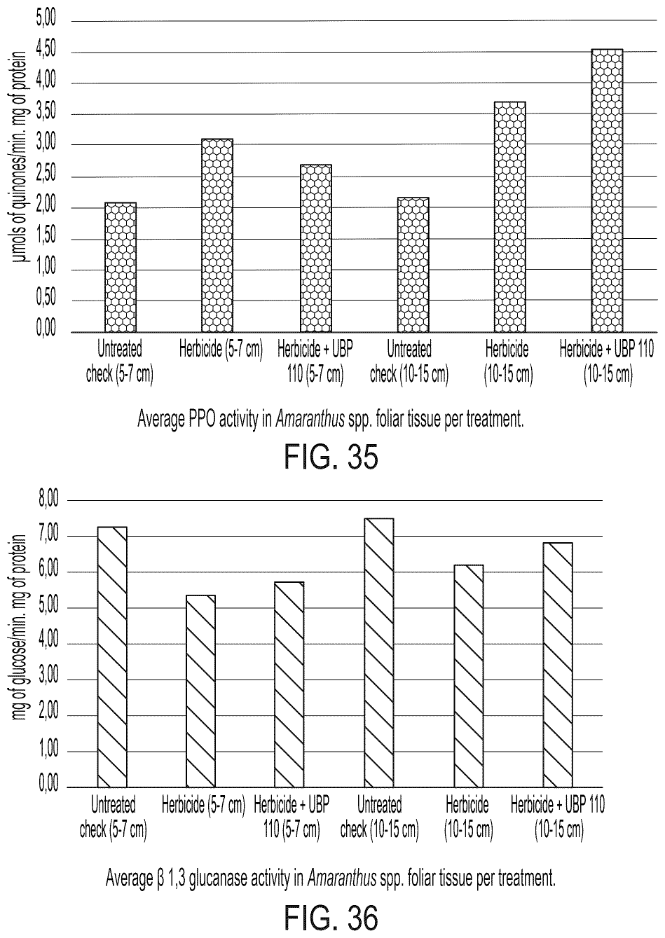

PPO activity was measured in a similar manner described above with respect to the soybean study and the results are shown in FIG. 35 and Table 36. Treatments that contained herbicide tended to induce PPO activity at both sizes of the weed. When the plants were 5-7 cm tall, there were not statistical differences between treatments. At 10-15 cm the activity of the enzyme raised significantly when herbicide was applied, especially with UBP110.

TABLE 36
Average PPO activity of Amaranthus spp. per treatment. Different
letters show significant differences (α: 0.05; Duncan Test)

| | PPO | | | |
|---|---|---|---|---|
| | (μmols of | | | |
| | quinones/ | | | |
| | minute · mg | | | |
| Treatment | of protein) | | | |
| Untreated check (5-7 cm) | 2.08 | | | C |
| Herbicide (5-7 cm) | 3.11 | | B | C |
| Herbicide + UBP (5-7 cm) | 2.70 | | B | C |
| Untreated check (10-15 cm) | 2.17 | A | | C |
| Herbicide (10-15 cm) | 3.69 | A | B | |
| Herbicide + UBP (10-15 cm) | 4.54 | A | | |

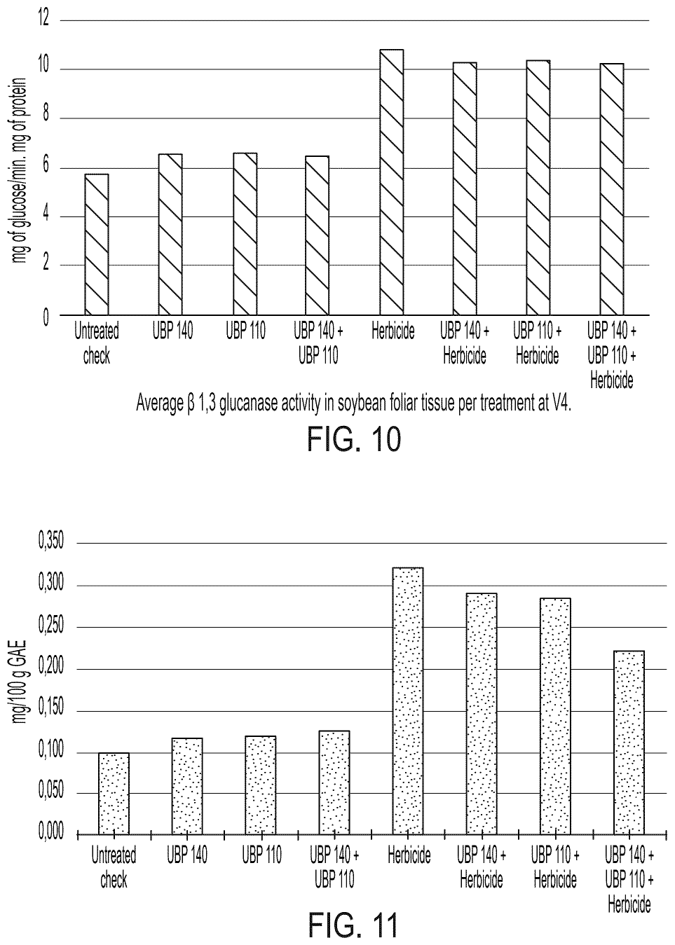

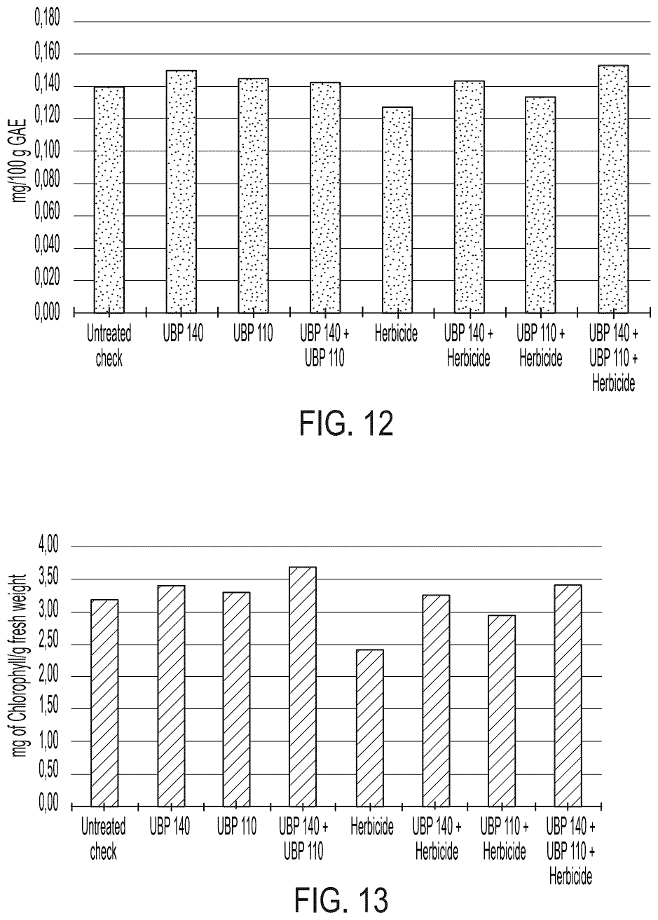

β1, 3 glucanase activity was measured in a similar manner described above with respect to the soybean study and the results are shown in FIG. 36 and Table 37. When the herbicide was applied, there was a tendency to slightly decrease the activity of the enzyme compared to the controls, at both sizes of the plant (FIG. 10). This was more pronounced in the absence of UBP110. In the smaller weed size, the decrease in activity was significant (Table 37). Data were transformed with LN to accomplish ANOVA requirements.

TABLE 37
Average β 1.3 glucanase activity of Amaranthus spp. per treatment.
Different letters show significant differences (α: 0.05; Test)

| | β 1.3 glucanase | | |
|---|---|---|---|
| | (mg of glucose/ | | |
| | minute · mg | | |
| Treatment | of protein) | | |
| Untreated check (5-7 cm) | 7.30 | A | |
| Herbicide (5-7 cm) | 5.34 | | B |
| Herbicide + UBP (5-7 cm) | 5.76 | | B |
| Untreated check (10-15 cm) | 7.55 | A | |
| Herbicide (10-15 cm) | 6.21 | A | |
| Herbicide + UBP (10-15 cm) | 6.84 | A | |

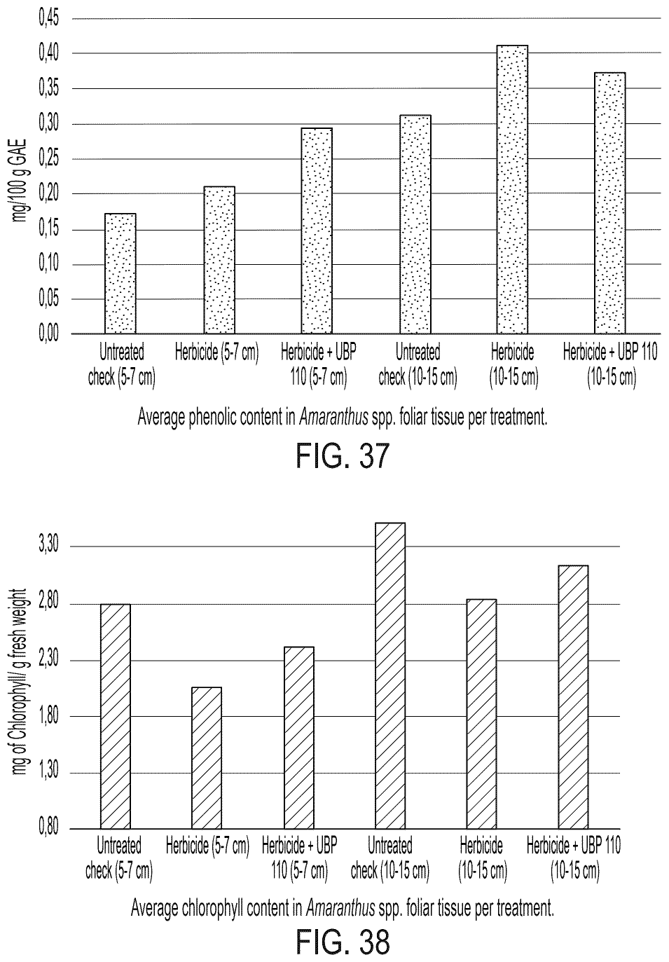

Total phenolic compounds were measured in a similar manner described above with respect to the soybean study and the results are shown in FIG. 37 and Table 38. Treatments that contained herbicide tended to raise the content of phenolic compounds vs the controls. When the plants were small, the highest polyphenol content significantly was shown by herbicide+UBP110 (FIG. 37, Table 38). When plants got bigger, the herbicide alone showed the greatest polyphenol content (FIG. 37). Although it did not differ significantly from the UBP110 mixture (Table 38).

Data were transformed with LN to meet ANOVA requirements. When the herbicide was applied, there was a tendency to slightly decrease the activity of the enzyme compared to the controls, at both sizes of the plant. This was more pronounced in the absence of UBP110. In the smaller weed size, the decrease in activity was significant (Table 38). Data were transformed with LN to accomplish ANOVA requirements.

TABLE 38
Average phenolic content per treatment. Different letters
show significant differences (α: 0.05; Duncan Test);

| | Total Phenolic | | | |
|---|---|---|---|---|
| | Compounds | | | |
| Treatment | (mg/100 g AE*) | | | |
| Untreated check (5-7 cm) | 0.17 | | | C |
| Herbicide (5-7 cm) | 0.21 | | | C |
| Herbicide + UBP (5-7 cm) | 0.29 | | B | |
| Untreated check (10-15 cm) | 0.31 | | B | |
| Herbicide (10-15 cm) | 0.41 | A | | |
| Herbicide + UBP (10-15 cm) | 0.38 | A | B | |

*GAE: Gallic Acid Equivalents

Chlorophyll content was measured in a similar manner described above with respect to the soybean study and the results are shown in FIG. 38 and Table 39. Herbicide tended to diminish the chlorophyll content of foliar tissue of Amaranthus spp. neither at an initial stage of growth or at a more advanced one (FIG. 38). When weeds were small, this reduction was significant for the herbicide alone compared with the untreated check (Table 13). The mixture of herbicide+UBP110 did not show statistical differences with the control at 5-7 cm (Table 39). When plants were 10-15 cm tall, there were no significant differences between treatments (Table 39). Data were transformed with LN to accomplish ANOVA requirements.

TABLE 39
Average chlorophyll content per treatment. Different letters
show significant differences (α: 0.05; Duncan Test)

| | Chlorophyll content | | | |
|---|---|---|---|---|
| | (mg of chlorophyll/ | | | |
| Treatment | g fresh weight) | | | |
| Untreated check (5-7 cm) | 2.81 | A | B | |
| Herbicide (5-7 cm) | 2.05 | | | C |
| Herbicide + UBP (5-7 cm) | 2.41 | | B | |
| Untreated check (10-15 cm) | 3.69 | A | | |
| Herbicide (10-15 cm) | 2.84 | A | B | |
| Herbicide + UBP (10-15 cm) | 3.14 | A | | |

This study showed when fomesafen was applied, the aerial and radical biomass of Amaranthus spp. was significantly reduced, as expected. There were no significant differences between the application of the herbicide alone or in combination with UBP110 at any of the weed sizes tested. For herbicidal control, there were no significant differences between treatments, nor at 5-7 cm nor at 10-15 cm weed size. However, the control percentage tended to diminish as weeds got bigger. There were no differences between treatments for the total protein content at any of the weed sizes tested. Herbicide treatments increased the oxidative stress of Amaranthus spp. significantly at both sizes of the weed tested. Treatments that contained UBP110 slightly reduced the stress of the weed compared to herbicide alone, but this was not significant. CAT and PAL activity tended to improve when herbicide was applied, regardless of the aggregate of UBP110, but differences were not significant. Herbicide treatments induced GPOX activity significantly, independent of the mixture with UBP110. Herbicide application tended to enhance PPO activity. When weeds were 10-15 cm, the improvement was significant and the mixture with UBP110 showed the greater activity of the enzyme. Treatments that contained herbicide tended to reduce the activity of $1,3 glucanase on Amaranthus spp., especially when the weeds were small. Herbicide application increased the content of phenolic compounds of the weed at any of the sizes tested. In weeds of 5-7 cm, herbicide+UBP 110 registered the greatest content of polyphenols. Chlorophyll content decreased at both weed sizes when herbicide was applied. Especially in absence of UBP110.

### Study 4: RNA for Corn Foliar Treatment

In this study, field corn plants were planted at growth chamber with 16/8 light/dark at 23-25° C. When the plants were at 4 leaves stage, UBP110 (150 g/ha) and DI water were used for spraying. The commercial dose rate of UBP110 (150 g/ha) was calculated for a small-scale experiment, and the diluted UBP was used in a track sprayer. The track sprayer allows replication of how the product would be applied in the field. Treated plants where then placed in a Conviron that is set to a predetermined temperature. At specific timepoints (6 and 24 hours), root and shoot plants from each treatment are used to collect tissue samples. The tissue samples for RNAseq analysis were immediately flash-frozen in liquid nitrogen and stored at −80° C. until RNA can be extracted and prepped for RT-qPCR. Data were compared between UBP110 and UTC at each time point.

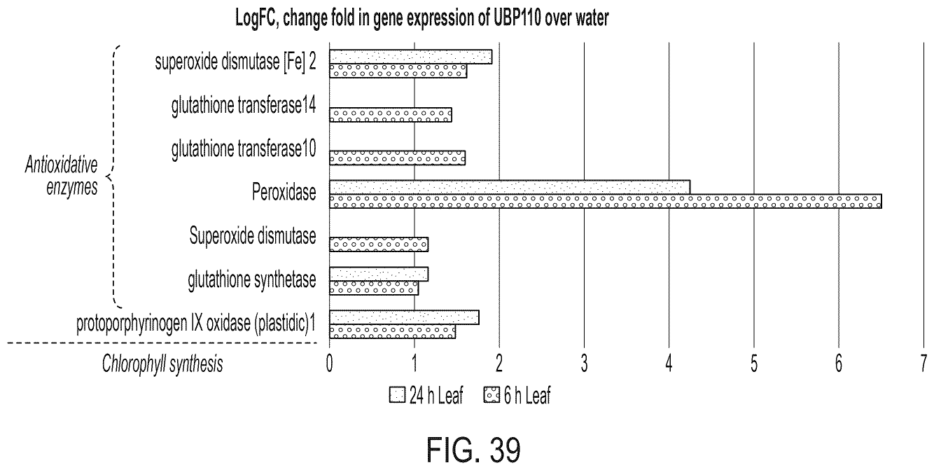

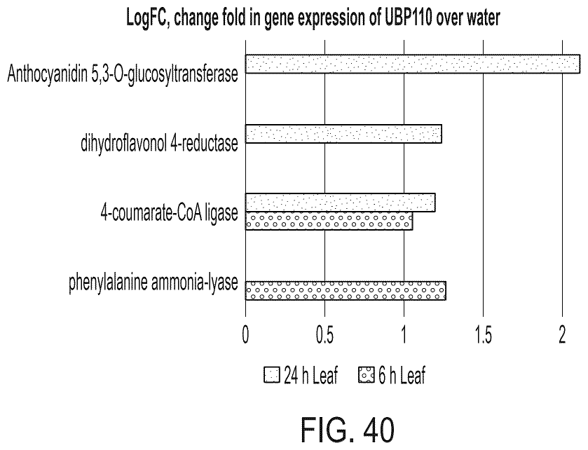

The results of the data from RNAseq analysis are shown in FIGS. 39 and 40. Glutathione-S-transferasel has been found to be important to mitigate herbicides' (formesafen included) negative impacts. Additionally, treatment with UBP reduces oxidative stress and necrosis. UBP is activating multiple pathways related to chlorophyl biosynthesis and oxidative stress mitigation to revert the negative impact of herbicides.

FIG. 39 shows a chart of the measured changes of gene expression for genes related to chlorophyll synthesis and oxidative stress tolerance, and FIG. 40 shows a chart of the measured changes of gene expression in the flavonoid paythway.

The examples above are presented to describe embodiments and utilities of the disclosure and are not meant to limit the invention unless otherwise stated in the claims appended hereto. Although this disclosure provides many specifics, these should not be construed as limiting the scope of any of the claims that follow, but merely as providing illustrations of some embodiments of elements and features of the disclosed subject matter. Other embodiments of the disclosed subject matter, and of their elements and features, may be devised which do not depart from the spirit or scope of any of the claims. Features from different embodiments may be employed in combination. Accordingly, the scope of each claim is limited only by its plain language and the legal equivalents thereto.

1-10. (canceled)

11. A method for reducing herbicide stress to a plant, the method comprising the steps of:
applying an herbicide to the plant; and
applying to at least one of the plant, a seed of the plant, or a substrate used for growing the plant, an effective amount of a composition comprising fulvic acid and poly-metallic humates (CPFAPH).

12. The method of claim 11, wherein the composition containing fulvic acid and poly-metallic humates (CPFAPH) comprises:
a growth enhancing component comprising a co-polymer of fulvic acid and poly-metallic humates (CPFAPH) present in an amount of from about 80% to about 90% by weight, based on a total weight of the composition;
one or more plant macro nutrients present in an amount of from about 3% to about 7% by weight, based on the total weight of the composition; and
one or more secondary nutrients, micronutrients, and biologically active trace-metals present in the amount of from about 3% to about 10% by weight, based on the total weight of the composition; wherein the one or more secondary nutrients, micronutrients, and biologically active trace-metals differ from CPFAPH.

13. The method of claim 12, wherein the one or more plant macro nutrients present in the amount of from about 3% to about 7% by weight, based on the total weight of the composition comprises compounds containing one or more of nitrogen, phosphorous, and potassium.

14. The method of claim 12, wherein the one or more secondary nutrients comprises compounds containing one or more of calcium, magnesium, and sulfur.

15. The method of claim 12, wherein the micronutrients comprise compounds containing one or more of zinc, copper, manganese, and iron.

16. The method of claim 12, wherein the biologically active trace-metals comprise heteromolecular trace-metal complexes.

17. The method of claim 12, wherein the biologically active trace-metals comprise one or more of molybdenum, vanadium, cobalt, and nickel.

18. The method of claim 16, wherein the heteromolecular trace-metal complexes comprise one or more of molybdenum, vanadium, cobalt, and nickel.

19. The method of claim 12, wherein the biologically active trace-metals comprise an amount of from about 1% to about 3% by weight, based on the total weight of the composition.

20. The method of claim 11, wherein the herbicide is fomesafen.

21. The method of claim 11, wherein the plant is cotton, sunflower, corn, wheat, rye, oats, millet, sorghum, rice or soybeans.

22. The method of claim 11, wherein the herbicide stress is oxidative stress.

23. A method for increasing biomass of a plant comprising the steps of:
applying an herbicide to the plant; and
applying to the plant, a seed of the plant, and/or a growing substrate for the plant, an effective amount of a composition comprising a composition containing fulvic acid and poly-metallic humates (CPFAPH).

24. The method of claim 23, wherein the method increases a root content of the plant.

25. The method of claim 23, wherein the composition containing fulvic acid and poly-metallic humates (CPFAPH) comprises:
a growth enhancing component comprising a co-polymer of fulvic acid and poly-metallic humates (CPFAPH) present in an amount of from about 80% to about 90% by weight, based on a total weight of the composition;
one or more plant macro nutrients present in an amount of from about 3% to about 7% by weight, based on the total weight of the composition; and
one or more secondary nutrients, micronutrients, and biologically active trace-metals present in the amount of from about 3% to about 10% by weight, based on the total weight of the composition; wherein the one or more secondary nutrients, micronutrients, and biologically active trace-metals differ from CPFAPH.

26. The method of claim 25, wherein the one or more plant macro nutrients present in the amount of from about 3% to about 7% by weight, based on the total weight of the composition comprises compounds containing one or more of nitrogen, phosphorous, and potassium.

27. The method of claim 25, wherein the one or more secondary nutrients comprises compounds containing one or more of calcium, magnesium, and sulfur; and wherein the micronutrients comprise compounds containing one or more of zinc, copper, manganese, and iron.

28. The method of claim 25, wherein the biologically active trace-metals comprise one or more of molybdenum, vanadium, cobalt, and nickel; and wherein the biologically active trace-metals comprise an amount of from about 1% to about 3% by weight, based on the total weight of the composition.

29. The method of claim 23, wherein the herbicide is fomesafen.

30. A method for reducing oxidative stress to a plant, the method comprising the steps of:
applying an herbicide to the plant; and
applying to the plant, a seed of the plant, and/or a growing substrate for the plant an effective amount of a composition comprising a composition containing fulvic acid and poly-metallic humates (CPFAPH).
